(19) United States
(12) Patent Application Publication
(10) Pub. No.: US 2010/0174527 A1
(43) Pub. Date: Jul. 8, 2010

(54) DICTIONARY REGISTERING SYSTEM, DICTIONARY REGISTERING METHOD, AND DICTIONARY REGISTERING PROGRAM

(75) Inventors: Kunihiko Sadamasa, Tokyo (JP); Shinichi Ando, Tokyo (JP)

Correspondence Address: Mr. Jackson Chen, 6535 N. STATE HWY 161, IRVING, TX, 75039, US

(73) Assignee: NEC CORPORATION, Tokyo (JP)

(21) Appl. No.: 12/601,486

(22) PCT Filed: May 8, 2008
(86) PCT No.: PCT/JP2008/058539

§ 371 Date: Nov. 23, 2009

(30) Foreign Application Priority Data
May 23, 2007 (JP) 2007-136660

(51) Int. Cl. G06F 17/27

(52) U.S. Cl. 704/9

(57) ABSTRACT

There is provided a dictionary registration system which makes it possible to register a word into a user dictionary while minimizing an adverse effect that the word may have on natural language processing, if any. The dictionary registration system performs natural language processing by using a user dictionary, and includes a data processing apparatus that performs the natural language processing by managing and using the user dictionary and a storage apparatus that retains system dictionary information and user dictionary information for use in the natural language processing. The storage apparatus includes the system dictionary information for use in the natural language processing, and the user dictionary. The data processing apparatus includes: a word information registering init that registers information on an input word into the user dictionary; a difference creating unit that creates differences in a result of processing between a first result of processing when the natural language processing is performed, by using the system dictionary, information and a second result of processing when the natural language processing is performed by using the system dictionary information and the user dictionary information; a correct-incorrect accepting unit that accepts correct-incorrect judgments as to whether changes from the first result of processing to the second result of processing are correct or incorrect, the changes corresponding to the differences created by the difference creating unit; and dictionary registration unit that registers registration information on the accepted word into the user dictionary along with part or all of pairs of the correct-incorrect judgments accepted and input sentences from which the differences given the respective correct-incorrect judgments are created.

### TECHNICAL FIELD

The present invention relates to a user dictionary registration system, a dictionary registration method, and a dictionary registration program for a natural language processing system such as a machine translation system. In particular, the present invention relates to a dictionary registration system, a dictionary registration method, and a dictionary registration program for performing natural language processing by using a user dictionary.

### BACKGROUND ART

With the advancement of computing power in recent years, various types of natural language processing systems have been put to practical use, including a machine translation system which translates a first language into a second language.

A natural language processing system has a default dictionary (hereinafter, referred to as “system dictionary”) for analyzing and processing input sentences with.

Aside from the system dictionary, the natural language processing system often has a framework for registering new words unregistered in the system dictionary and words and expressions of user's own into a user-specific dictionary (hereinafter, referred to as “user dictionary”) so that the user can personally improve the result of analysis of the natural language processing.

The words registered in the user dictionary typically have priority over those in the system dictionary.

Due to the priority of the words in the user dictionary over those in the system dictionary, however, inappropriate words registered in the user dictionary can sometimes deteriorate the overall result of analysis.

There has thus been proposed a system that displays a warning to the user if the user attempts to register a word that may have an adverse effect when registered in the user dictionary.

An example of such a dictionary registration system is described in PTL 1 (hereinafter, referred to as “related technology 1”). The dictionary registration system of the related technology 1 includes registration item inputting unit, dictionary registration item inspecting unit, and error message display/processing selecting unit.

The dictionary registration system of such configuration using the related technology 1 makes the following operations.

The registration item inputting unit initially accepts a new entry word to be registered in the user dictionary and relevant information such as a part of speech and a translation.

Next, the dictionary registration item inspecting unit checks if the input entry word satisfies a certain condition that is determined in advance. Examples of the certain condition include: that the entry word overwrites an existing function word; that there is an existing word having the same character string as that of the entry word but with a different part of speech; and that the headword of the entry word coincides with the character string of a conjugation of an existing word.

If the condition is satisfied, the error message display/processing selecting unit displays an error display corresponding to the condition (“The word to be registered, [symbol] coincides with the continuative form of the verb [symbol] [symbol] in the standard dictionary. Care should be taken for registration”) and user options (“Register”/“Modify entry”/“Cancel registration”).

Finally, the processing selecting unit performs the processing selected by the user.

According to the related technology 1, however, there are only three alternatives for a word that may have an adverse effect: to register the word even with knowledge of the adverse effect, not to register the word, and to register another word that has a less adverse effect. It has thus been difficult to register the word itself and suppress the adverse effect.

Known examples of the word that is likely to have an adverse effect when registered in the user dictionary include function words such as particles and auxiliary verbs.

There has been proposed a system that can register some of the function words, or long-unit particles having the form of a particle(s)+a verb(s), in the user dictionary while suppressing their adverse effect (hereinafter, referred to as related technology 2). Among the examples of the long-unit particles are [symbol] [symbol] and

[symbol]

PTL 2 describes an example of the dictionary registration system using the related technology 2. The dictionary registration system of the related technology 2 includes registration item inputting unit, headword dividing unit, and dictionary registration unit.

The dictionary registration system of such configuration using the related technology 2 makes the following operations.

The registration item inputting unit initially accepts a new entry word to be registered in the user dictionary and relevant information such as a part of speech and a translation.

Next, the headword dividing unit divides the headword into morphemes if the input word is a function word. Finally, the dictionary registration unit associates the divided morphemes with the original headword and the relevant information.

A syntactic analysis system uses the user dictionary that is created by the dictionary registration system of the related technology 2. When an input sentence is morphologically analyzed and found to include the divided morphemes, the syntactic analysis system judges whether a certain condition is satisfied, including that the morphemes do not fall on the end of the sentence if the undivided morpheme is an attributive particle and that the morphemes are not directly followed by an auxiliary verb if the undivided morpheme is continuative.

If the certain condition is satisfied, the syntactic analysis system restores the undivided morpheme and continues processing.

This makes it possible to register a long-unit particle in the form of a particle(s)+a verb(s) while suppressing its adverse effect.

Citation List

Patent Literature

PTL 1 JP-A-07-085059

PTL 2 JP-A-11-003336

### SUMMARY OF INVENTION

Technical Problem

As described above, the related technology 2 has proposed nothing but a method of dealing with only a small portion of function words among the words that may have an adverse effect. It has thus been difficult to deal with other types of words.

Examples of the other words that may have an adverse effect include independent words that have an internal structure.

Description will now be given of an example of machine translation where the word [symbol] which consists of the two Japanese words [symbol] and [symbol] shall be translated into a translation “dark blue”.

In such a case, it would seem natural to register the entire [symbol] as a single noun. If [symbol] is registered in the user dictionary as a single noun, however, an input that includes a modification to [symbol] in the internal structure fails to be analyzed.

For example, if the entire [symbol] is registered as a single noun and an input [symbol] [symbol] is made, the input is interpreted as [symbol] (adverb)/ [symbol] (noun)”. Since an adverb is typically not allowed to modify a noun, the analysis results in a failure.

Such a problem is not limited to indeclinable words such as a noun, but also matters with declinable words having an internal structure, such as [symbol] [symbol] (verb)” and [symbol] (adjective)”.

Adverse effects can also occur from dictionary registrations that conflict with existing function words and conjugated words, exemplified in PTL 1, like the registration of such independent words as [symbol] (proper noun)” and [symbol] (proper noun)”.

These independent words that may have an adverse effect are not able to be registered by using either of the related technologies 1 and 2. As mentioned previously, the related technology 2 can only deal with function words that have the form of a particle(s)+a verb(s).

It is thus an object of the present invention to provide a dictionary registration system and its method and program which make it possible to register a word into a user dictionary while minimizing an adverse effect that the word may have on natural language processing, if any.

Solution to Problem

According to the present invention, there is provided a dictionary registration system for performing natural language processing by using a user dictionary, the system comprising: a data processing apparatus that performs the natural language processing by managing and using the user dictionary; and a storage apparatus that retains system dictionary information and user dictionary information for use in the natural language processing, wherein: the storage apparatus includes the system dictionary information for use in the natural language processing; and the user dictionary; and the data processing apparatus includes a word information registering unit that registers information on an input word into the user dictionary, a difference creating unit that creates differences in a result of processing between a first result of processing when the natural language processing is performed by using the system dictionary information and a second result of processing when the natural language processing is performed by using the system dictionary information and the user dictionary information, a correct-incorrect accepting unit that accepts correct-incorrect judgments as to whether changes from the first result of processing to the second result of processing are correct or incorrect, the changes corresponding to the differences created by the difference creating unit, and a dictionary registration unit that registers registration information on the accepted word into the user dictionary along with part or all of pairs of the correct-incorrect judgments accepted and input sentences from which the differences given the respective correct-incorrect judgments are created.

According to the present invention, there is also provided a dictionary registration system for performing natural language processing by using a user dictionary, the system comprising: a data processing apparatus that performs the natural language processing by managing and using the user dictionary; and a storage apparatus that retains system dictionary information and user dictionary information for use in the natural language processing, wherein: the storage apparatus includes the system dictionary information for use in the natural language processing, and the user dictionary; and the data processing apparatus includes a word information registering unit that registers information on an input word into the user dictionary, a difference creating unit that creates differences in a result of processing between a first result of processing when the natural language processing is performed by using the system dictionary information and a second result of processing when the natural language processing is performed by using the system dictionary information and the user dictionary information, a correct-incorrect accepting unit that accepts correct-incorrect judgments as to whether changes from the first result of processing to the second result of processing are correct or incorrect, the changes corresponding to the differences created by the difference creating unit, a parameter learning unit that calculates either one or a combination of a use condition and a using score of the accepted word from the correct-incorrect judgments accepted, and a dictionary registration unit that registers registration information on the accepted word into the user dictionary along with either one or a combination of the use condition and score calculated.

According to the present invention, there is also provided a dictionary registration method for a system that performs natural language processing by using a user dictionary, the system including a data processing apparatus that performs the natural language processing by managing and using the user dictionary and a storage apparatus that retains system dictionary information and user dictionary information for use in the natural language processing, the method comprising: a word information registering step in which the data processing apparatus registers information on an input word into the user dictionary; a difference creating step in which the data processing apparatus creates differences in a result of processing between a first result of processing when the natural language processing is performed by using the system dictionary information and a second result of processing when the natural language processing is performed by using the system dictionary information and the user dictionary information; a correct-incorrect accepting step in which the data processing apparatus accepts correct-incorrect judgments as to whether changes from the first result of processing to the second result of processing are correct or incorrect, the changes corresponding to the differences created by the difference creating step; and a dictionary registration step in which the data processing apparatus registers registration information on the accepted word into the user dictionary along with part or all of pairs of the correct-incorrect judgments accepted and input sentences from which the differences given the respective correct-incorrect judgments are created.

According to the present invention, there is also provided a dictionary registration method for a system that performs natural language processing by using a user dictionary, the system including a data processing apparatus that performs the natural language processing by managing and using the user dictionary and a storage apparatus that retains system dictionary information and user dictionary information for use in the natural language processing, the method comprising: a word information registering step in which the data processing apparatus registers information on an input word into the user dictionary; a difference creating step in which the data processing apparatus creates differences in a result of processing between a first result of processing when the natural language processing is performed by using the system dictionary information and a second result of processing when the natural language processing is performed by using the system dictionary information and the user dictionary information; a correct-incorrect accepting step in which the data processing apparatus accepts correct-incorrect judgments as to whether changes from the first result of processing to the second result of processing are correct or incorrect, the changes corresponding to the differences created by the difference creating step; a parameter learning step in which the data processing apparatus calculates either one or a combination of a use condition and a using score of the accepted word from the correct-incorrect judgments accepted; and a dictionary registration step in which the data processing apparatus registers registration information on the accepted word into the user dictionary along with either one or a combination of the use condition and score calculated.

According to the present invention, there is also provided a dictionary registration program for performing natural language processing by managing and using a user dictionary, the program making a computer to implement: a word information registering function of registering information on an input word into the user dictionary; a difference creating function of creating differences in a result of processing between a first result of processing when the natural language processing is performed by using the system dictionary information and a second result of processing when the natural language processing is performed by using the system dictionary information and the user dictionary information; a correct-incorrect accepting function of accepting correct-incorrect judgments as to whether changes from the first result of processing to the second result of processing are correct or incorrect, the changes corresponding to the differences created by the difference creating function; and a dictionary registration function of registering registration information on the accepted word into the user dictionary along with part or all of pairs of the correct-incorrect judgments accepted and input sentences from which the differences given the respective correct-incorrect judgments are created.

According to the present invention, there is also provided a dictionary registration program for performing natural language processing by managing and using a user dictionary, the program making a computer to implement: a word information registering function of registering information on an input word into the user dictionary; a difference creating function of creating differences in a result of processing between a first result of processing when the natural language processing is performed by using the system dictionary information and a second result of processing when the natural language processing is performed by using the system dictionary information and the user dictionary information; a correct-incorrect accepting function of accepting correct-incorrect judgments as to whether changes from the first result of processing to the second result of processing are correct or incorrect, the changes corresponding to the differences created by the difference creating function; a parameter learning function of calculating either one or a combination of a use condition and a using score of the accepted word from the correct-incorrect judgments accepted; and a dictionary registration function of registering registration information on the accepted word into the user dictionary along with either one or a combination of the use condition and score calculated.

### ADVANTAGES EFFECTS OF INVENTION

According to the present invention, analysis processing is performed by using the use condition and score that are determined in advance, so that the use of the word can be suppressed if there is made an input similar to that of a case where the user has judged that the change is incorrect. It is therefore possible to register the word into the user dictionary while minimizing an adverse effect that the word may have on natural language processing, if any.

### BRIEF DESCRIPTION OF DRAWINGS

FIG. 1 A block diagram illustrating the configuration of a best mode for carrying out a first invention according to the present invention (during user dictionary registration).

FIG. 2 A block diagram illustrating the configuration of the best mode for carrying out the first invention according to the present invention (during analysis using the user dictionary).

FIG. 3 A flowchart illustrating the operation of the best mode for carrying out the first invention according to the present invention (during user dictionary registration).

FIG. 4 A flowchart illustrating the operation of the best mode for carrying out the first invention according to the present invention (during analysis using the user dictionary).

FIG. 5 A block diagram illustrating the configuration of a best mode for carrying out a second invention according to the present invention (during user dictionary registration).

FIG. 6 A block diagram illustrating the configuration of the best mode for carrying out the second invention according to the present invention (during analysis using the user dictionary).

FIG. 7 A flowchart illustrating the operation of the best mode for carrying out the second invention according to the present invention (during user dictionary registration).

FIG. 8 A flowchart illustrating the operation of the best mode for carrying out the second invention according to the present invention (during analysis using the user dictionary).

FIG. 9 A first concrete example of target sentences to be used for parameter learning according to a first example.

FIG. 10 The result of morphological analysis and the result of syntactic analysis of the first concrete example when the word [symbol] is not used.

FIG. 11 The result of morphological analysis and the result of syntactic analysis of the first concrete example when the word [symbol] is used.

FIG. 12 The result of feature extraction for parameter learning purpose and accepted correct-incorrect judgments that are obtained from the first concrete example.

FIG. 13 A concrete example of a user interface of the correct-incorrect accepting unit according to the first example.

FIG. 14 A table represented a concrete example of knowledge to be used by the parameter learning unit according to the first example.

FIG. 15 The result of morphological analysis and the result of syntactic analysis on an example of input when an language processing unit of the first example is in operation without using the word

[symbol]

FIG. 16 The result of morphological analysis and the result of syntactic analysis of the foregoing example, where the word [symbol] is used.

FIG. 17 Features extracted from the example for the sake of use condition judgment.

FIG. 18 A second concrete example of target sentences to be used for parameter learning according to the first example.

FIG. 19 The result of morphological analysis and the result of syntactic analysis of the second concrete example when the word [symbol] is not used.

FIG. 20 The result of morphological analysis and the result of syntactic analysis of the second concrete example when the word [symbol] is used.

FIG. 21 The result of feature extraction for parameter learning purpose and accepted correct-incorrect judgments that are obtained from the second concrete example.

### REFERENCE SIGNS LIST

1: input apparatus

2: data processing apparatus

3: storage apparatus

4: output apparatus

20: language processing unit

21: registration information input unit

22: difference creating unit

23: correct-incorrect accepting unit

24: parameter learning unit

25: dictionary registration unit

31: system dictionary storing unit

32: user dictionary storing unit

### DESCRIPTION OF EMBODIMENTS

Next, a best mode for carrying out the invention will be described in detail with reference to the drawings.

First Exemplary Embodiment

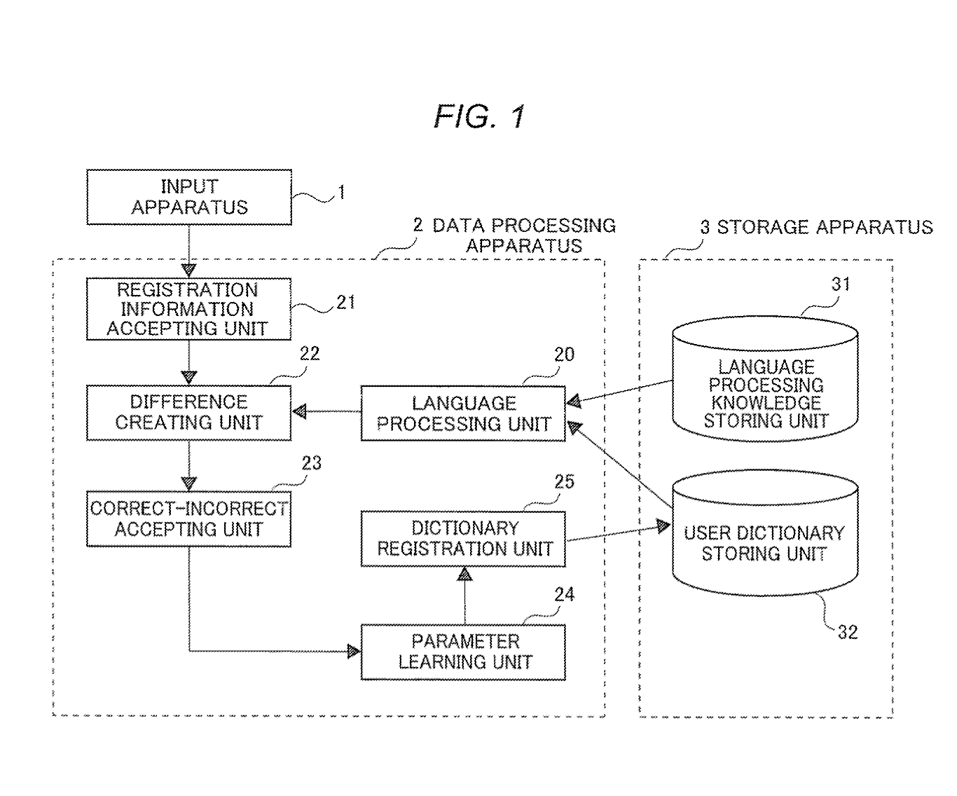

FIG. 1 is a block diagram illustrating the configuration of a first exemplary embodiment for carrying out the present invention when registering a word in a user dictionary.

Referring to FIG. 1 for description, the first exemplary embodiment of the present invention includes an input apparatus 1, a data processing apparatus 2, and a storage apparatus 3.

The data processing apparatus 2 includes a language processing unit 20, a registration information accepting unit 21, a difference creating unit 22, a correct-incorrect accepting unit 23, a parameter learning unit 24, and a dictionary registration unit 25.

The storage apparatus 3 includes a language processing knowledge storing unit 31 and a user dictionary storing unit 32.

Such components generally make the following operations, respectively.

The language processing knowledge storing unit 31 contains headwords, parts of speech, translations, and meaning classifications of words, word information, and grammatical information that are necessary for the language processing unit 20 to perform language processing with.

The user dictionary storing unit 32 is a part that contains a dictionary for the language processing unit 20 to use, in which a user personally registers words that are not contained in the language processing knowledge storing unit 31.

The language processing unit 20 is a part that applies processing to an input by using the language processing knowledge storing unit 31 and the user dictionary in the user dictionary storing unit 32.

The input is often processed in units of sentences, whereas the processing may be in other units than a sentence, such as by phrase, by several sentences, and by paragraph.

In this respect, the description of the present exemplary embodiment is predicated on sentence-by-sentence inputs, which will hereinafter be referred to as “sentences” or “input sentences.”

The language processing unit 20 may perform various types of processing as far as language processing that involves the processing of dividing an input sentence into words by using a dictionary is concerned.

Examples include: morphological analysis processing of dividing an input sentence into words and assigning parts of speech thereto; syntactic analysis processing of determining the relationship between words after a morphological analysis; machine translation processing of translating an input sentence into another language for output; speech synthesis processing of synthesizing an input sentence into speech for output; and language model creation processing of creating a language model for use in speech recognition processing.

What the specific content of the language processing of the unit is like is irrelevant to the essence of the present invention, and is thus not limited in particular.

When using the user dictionary that is created by using the user dictionary registration system of the present invention, the processing is characteristically performed by using parameters that are obtained by the parameter learning unit 24. Description thereof will be given later.

The registration information accepting unit 21 accepts the headword of a word to be registered in the user dictionary, and its related information including a part of speech, a translation, and meaning information. The registration information to be accepted here is the information that is needed by the language processing unit 20, and thus varies depending on the content of the processing that the language processing unit 20 performs.

For example, if the language processing unit 20 performs morphological analysis processing, it is typical to accept the headword and part of speech of the word.

When the language processing unit 20 performs machine translation processing, information on a translation and the part of speech of the translation, and sometimes meaning information and the like, are typically needed aside from the headword and part of speech of the word.

The difference creating unit 22 displays differences in the result of analysis of the language processing unit 20 between when the word input from the registration information accepting unit 21 is used and when not.

The documents to create differences from may be prepared in advance, may be specified by the user at the time of registration, or may be dynamically retrieved and acquired from a location where large amounts of documents are stored, such as the Internet and a document management server.

The differences can be displayed by various methods. In a most simple method, for example, the result of analysis when the word is used and the result of analysis when not may be displayed next to each other.

The results of analysis of the language processing unit 20 preferably are text documents. When the results of analysis are output as text documents, a commonly-available difference creation tool for text documents may be used.

Differences in the in-process result of analysis of the language processing unit 20 may also be displayed. For example, syntactic analysis processing is typically performed after morphological analysis processing. Differences occurring in the morphological analysis processing may thus be displayed.

Machine translation processing is typically performed after morphological analysis processing and syntactic analysis processing. Differences occurring in the morphological analysis processing and those in the syntactic analysis processing both may be displayed.

The correct-incorrect accepting unit 23 displays the differences created by the difference creating unit 22, and accepts from the user a correct-incorrect judgment on each of the differences as to whether the result of analysis changes to a correct one or incorrect one when the word is used as compared to when not.

The correct-incorrect accepting unit 23 preferably accepts two values, like o for a correct change and x for an incorrect change. Note that the correct-incorrect judgment need not be made on all the differences displayed. Three values may be accepted like Δ for a case where it is unknown whether the change is correct or incorrect, aside from o and x. In such a case, the word given Δ will not be subjected to processing of subsequent stages.

Based on the correct-incorrect judgments input by the correct-incorrect accepting unit 23, the parameter learning unit 24 determines parameters including a use condition and a using score of the word that is accepted by the registration information accepting unit 21 and is being registered in the user dictionary by the dictionary registration unit 25.

The use condition refers to a condition for the word to be used by the language processing unit 20 which uses the user dictionary. Specifically, when the language processing unit 20 accepts an input to be analyzed, the language processing unit 20 uses the word for analysis only if the input matches with the use condition.

The using score is a score to be taken into account as the weight of the word when the word is used in a natural language analysis' system that uses the user dictionary.

The result of analysis of natural language processing often includes a plurality of ambiguities, and scores for indicating validities to the language processing system are typically granted for the respective ambiguities. The using score is added to the scores that indicate the validities in using the word, so that the using score functions to raise or lower the priorities of the ambiguities in using the word. The scores may be continuous quantities or discrete quantities.

The dictionary registration unit 25 registers the registration information on the word accepted by the registration information accepting unit 21 into the user dictionary in the user dictionary storing unit 32 along with the use condition and using score of the word obtained by the parameter learning unit 24.

The registration information on the word may be registered with either one or both, or even neither, of the use condition and using score of the word.

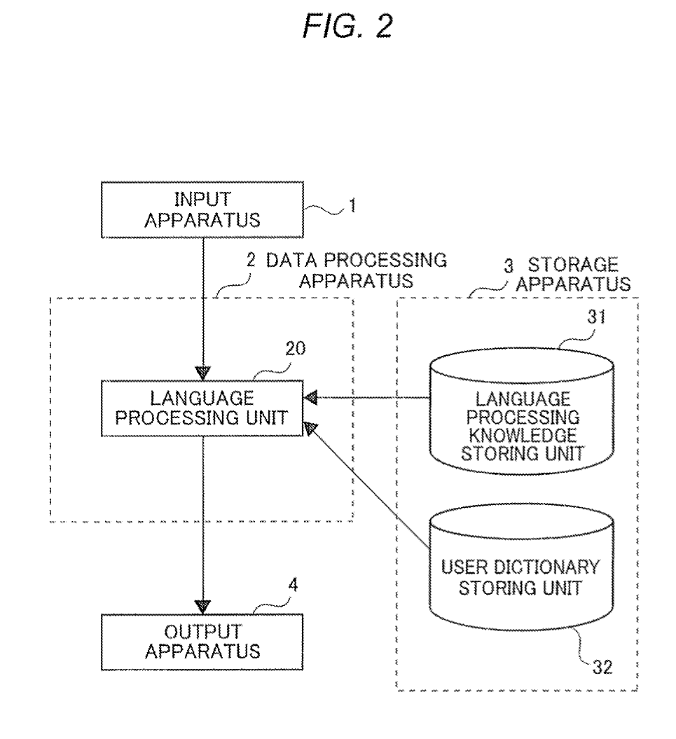

Next, the configuration of the first exemplary embodiment for carrying out the invention during analysis using the user dictionary will be described with reference to a block diagram of FIG. 2.

Referring to FIG. 2, the first exemplary embodiment of the present invention (during analysis using the user dictionary) includes an input apparatus 1, a data processing apparatus 2, a storage apparatus 3, and an output apparatus 4.

The data processing apparatus 2 includes a language processing unit 20.

The storage apparatus 3 includes a language processing knowledge storing unit 31 and a user dictionary storing unit 32.

Such components generally make the following operations, respectively.

The language processing knowledge storing unit 31 contains word information such as headwords of words, parts of speech, translations, and meaning classifications, and grammar information that are necessary for the language processing unit 20 to perform language processing with.

The user dictionary storing unit 32 is a part that contains a user dictionary for the language processing unit 20 to use, in which a user personally registers words that are not contained in the language processing knowledge storing unit 31.

The input apparatus 1 is an apparatus for accepting an input to be processed by the language processing unit 20.

The language processing unit 20 is a part that applies some kind of processing to the input by using language processing knowledge stored in the language processing knowledge storing unit 31 and the user dictionary stored in the user dictionary storing unit 32.

The language processing unit 20 and the language processing knowledge stored in the language processing knowledge storing unit 31 are preferably the same as the language processing unit 20 and the language processing knowledge stored in the language processing knowledge storing unit 31 that are used by the user dictionary registration system of the present invention when creating the user dictionary.

The language processing unit 20 performs processing by using the words in the user dictionary. As mentioned previously, the language processing unit 20 characteristically performs the processing by using use conditions and using scores that are obtained by the parameter learning unit 24 and registered with the words.

The terms “use condition” and “using score” employed here have the same meanings as described above.

The output apparatus 4 has the function of outputting the result of processing of the language processing unit 20.

Next, the overall operation of the present exemplary embodiment will be described in detail.

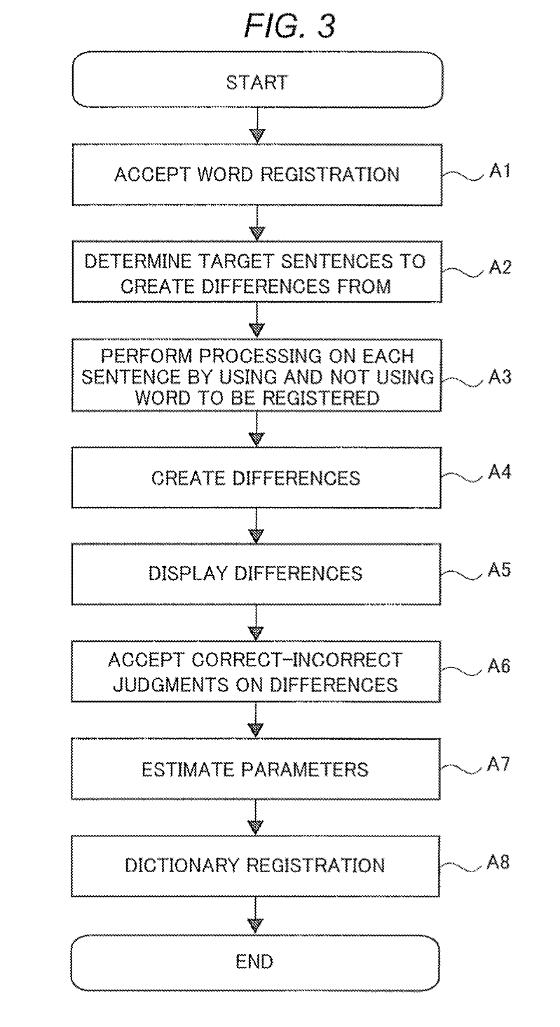

Firstly, the operation of the present exemplary embodiment when performing user dictionary registration will be described with reference to FIG. 1 and the flowchart of FIG. 3.

The registration information accepting unit 21 initially accepts registration information including the headword of a word to be registered in the user dictionary and its part of speech, translation, and meaning information from a user (step A1 in FIG. 3).

Next, the difference creating unit 21 determines a target document to create differences from (step A2).

The language processing unit 20 then creates the result of processing when each sentence in the target document is processed without the word accepted at step A1 being temporarily registered in the user dictionary, and the result of processing when each sentence is processed with the word temporarily registered in the user dictionary (step A3).

For the temporary registration, parameters calculated by the parameter learning unit will not be granted. That is, since the temporary registration is all temporary and not actual, the word is used without a use condition being granted or a using score changed.

Next, the difference creating unit 21 creates differences between the two results of processing obtained (step A4). The difference creating unit 23 then presents the information on the differences obtained to the user (step A5).

The correct-incorrect accepting unit 23 also makes the user compare each of the differences presented at step AS between when the word is used and when not, and accepts a correct-incorrect judgment from the user as to whether the result of analysis changes to a correct one or incorrect one when the word is used (step A6).

Based on the correct-incorrect judgments input by the correct-incorrect accepting unit 23, the parameter learning unit 24 determines the use condition and using score of the word so as to match with the correct-incorrect judgments (step A7).

Finally, the dictionary registration unit 25 registers the registration information accepted at step A1 into the user dictionary along with the use condition and using score obtained at step A7 (step A8).

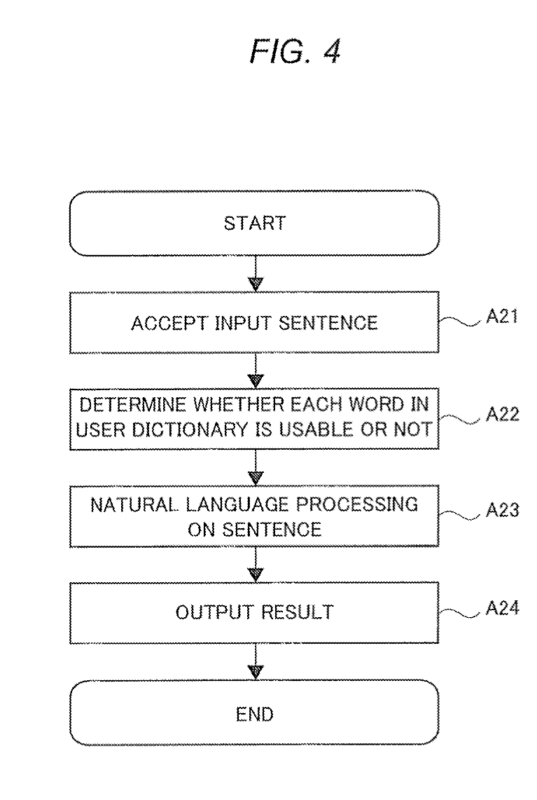

Secondly, the operation of the present exemplary embodiment during analysis will be described with reference to FIG. 2 and the flowchart of FIG. 4.

Initially, the input apparatus I accepts an input sentence to be processed (step A21 in FIG. 4).

Next, when a word in the user dictionary is used as an ambiguity of the input sentence, the language processing unit 20 determines whether the word is usable or not based on if the location of occurrence of the word in the input sentence satisfies the use condition that is registered with the word (step A22).

If the word in the user dictionary is determined to be usable, the word will be used in the language processing of subsequent stages. If the word in the user dictionary is determined to be unusable, on the other hand, the word will not be used in the language processing of the subsequent stages.

The language processing unit 20 further processes the input sentence (step A23).

The language processing unit 20 may perform various types of processing as far as language processing that involves the processing of dividing an input sentence into words by using a dictionary is concerned.

Examples include: morphological analysis processing of dividing an input sentence into words and assigning parts of speech thereto; syntactic analysis processing of determining the relationship between words after a morphological analysis; machine translation processing of translating an input sentence into another original language for output; speech synthesis processing of synthesizing an input sentence into speech for output; and language model creation processing of creating a language model for use in speech recognition processing. What kind of language processing will be performed is irrelevant to the essence of the present invention. The specific content of the processing of the language processing limit 20 is thus not limited.

Note that when the language processing unit 20 uses a word in the user dictionary and its using score is registered along with the word, the language processing unit 20 adjusts the score of validity of the ambiguity in the processing that uses the word, by adding the using score to the score of validity each time the word appears in the input sentence.

The result of processing that maximizes the validity score is then output from the language processing unit 20.

Finally, the output apparatus 4 outputs the result of processing that is output from the language processing unit 20 (step A24).

Description will now be given of the effect of the first exemplary embodiment.

In the present exemplary embodiment, differences that are created by the difference creating unit, occurring in the result of analysis of the language processing unit depending on if a word to be registered is used or not, are displayed so that the user can make correct-incorrect judgments as to whether the result of analysis changes to a correct one or incorrect one when the word is used.

Based on the correct-incorrect judgments, such a condition as to use the word to be registered can be learned from peripheral information and the like of the word to be registered in cases where the user judges that the result of analysis changes to a correct one, and such a condition as not to use the word in cases where the user judges that the result of analysis changes to an incorrect one. It is also possible to estimate such a using score of the word that enables the same discrimination, and register the using score in the user dictionary along with the registration information on the word.

Besides, the condition and the score obtained thus are used to perform analysis processing, so that the use of the word is suppressed if an input made to a language analysis unit is similar to that of the case where the user has judged that there occurs an incorrect change. This makes it possible to suppress adverse effects from the registered word.

Second Exemplary Embodiment

Next, another best mode for carrying out the invention will be described in detail with reference to the drawings.

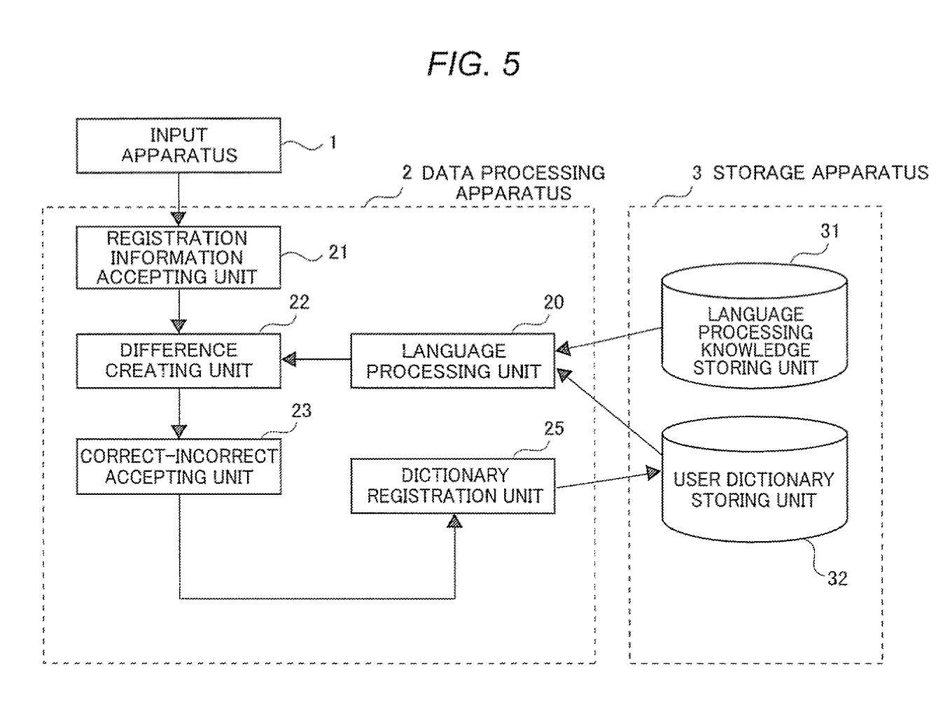

FIG. 5 is a block diagram illustrating the configuration of a second exemplary embodiment for carrying out the present invention during user dictionary registration.

Referring to FIG. 5 for description, the second exemplary embodiment of the present invention (during user dictionary registration) includes an input apparatus 1, a data processing apparatus 2, and a storage apparatus 3.

The data processing apparatus 2 includes a language processing unit 20, a registration information accepting unit 21, a difference creating unit 22, a correct-incorrect accepting unit 23, and a dictionary registration unit 25.

The storage apparatus 3 includes a language processing knowledge storing unit 31 and a user dictionary storing unit 32.

It should be noted that the input apparatus 1, the language processing unit 20, the registration information accepting unit 21, the difference creating unit 22, the correct-incorrect accepting unit 23, the language processing knowledge storing unit 31, and the user dictionary storing unit 32 are the same as the components of the first exemplary embodiment (during user dictionary registration) with the respective corresponding signs.

Such components generally make the following operations, respectively.

The language processing knowledge storing unit 31 contains headwords of words, parts of speech, translations, meaning classifications, word information, and grammar information that are necessary for the language processing unit 20 to perform language processing with.

The user dictionary storing unit 32 is a part that contains a user dictionary for the language processing unit 20 to use, in which a user personally registers words that are not contained in the language processing knowledge storing unit 31.

The language processing unit 20 is a part that applies processing to an input by using the language processing knowledge storing unit 31 and the user dictionary stored in the user dictionary storing unit 32.

The registration information accepting unit 21 is a part that accepts the headword of a word to be registered in the user dictionary and its related information including a part of speech, a translation, and meaning information.

The difference creating unit 22 is a part that displays differences in the result of analysis of the language processing unit 20 between when the word input by the registration information accepting unit 21 is used and when not.

The correct-incorrect accepting unit 23 is a part that displays the differences created by the difference creating unit 22, and accepts from the user a correct-incorrect judgment on each of the differences as to whether the result of analysis changes to a correct one or incorrect one when the word is used as compared to when not.

The dictionary registration unit 25 registers the registration information on the word accepted by the registration information accepting unit 21 into the user dictionary stored in the user dictionary storing unit 32, along with part or all of pairs of the correct-incorrect judgments accepted by the correct-incorrect accepting unit 23 and sentences from which the differences given the 10. correct-incorrect judgments are created.

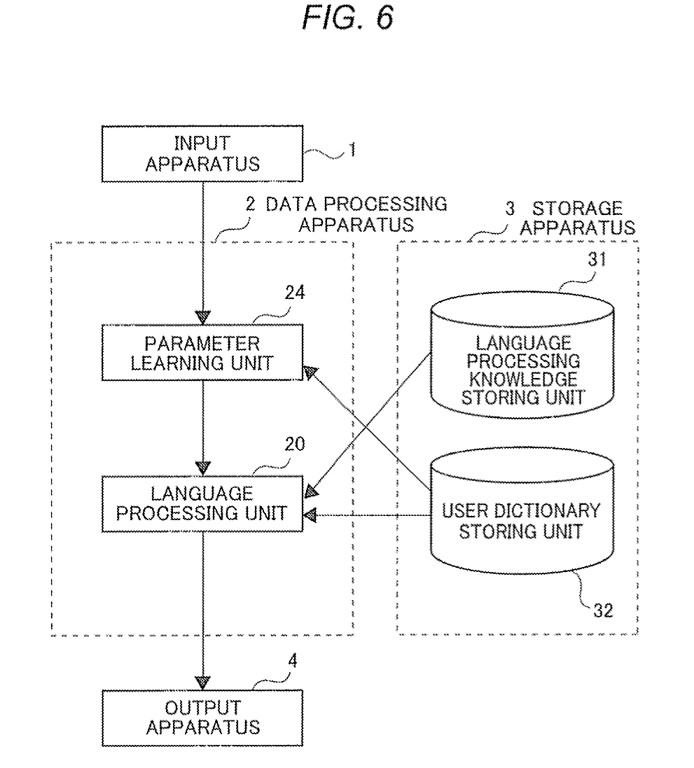

FIG. 6 is a block diagram illustrating the configuration of the second exemplary embodiment for carrying out the present invention when performing analysis using the user dictionary.

Referring to FIG. 6 for description, the second exemplary embodiment of the present invention (during analysis using the user dictionary) includes an input apparatus 1, a data processing apparatus 2, a storage apparatus 3, and an output apparatus 4.

The data processing apparatus 2 includes a language processing unit 20 and a parameter learning unit 24.

The storage apparatus 3 includes a language processing knowledge storing unit 31 and a user dictionary storing unit 32.

It should be noted that the language processing knowledge storing unit 31 and the input apparatus I are the same as those of the first exemplary embodiment (during analysis using the user dictionary). The data processing apparatus 2 is almost the same as that of the first exemplary embodiment (during analysis using the user dictionary). Differences will be described later.

The parameter learning unit 24 is almost the same as the parameter learning unit 24 of the first exemplary embodiment (during user dictionary registration). Differences will be described later.

Such components generally make the following operations, respectively.

The language processing knowledge storing unit 31 contains language processing knowledge including headwords of words, parts of speech, translations, meaning classifications, word information, and grammar information that are necessary for the language processing unit 20 to perform language processing with.

The user dictionary storing unit 32 is a part that contains a user dictionary for the language processing unit 20 to use, in which a user personally registers words that are not contained in the language processing knowledge storing unit 31.

Note that, in the first exemplary embodiment, there are recorded the use conditions and using scores of the respective words registered. The second exemplary embodiment differs in that part or all of the pairs of the correct-incorrect judgments and the sentences from which the differences given the correct-incorrect judgments are created are recorded by the correct-incorrect accepting unit 23 of the second exemplary embodiment (during user dictionary registration).

The input apparatus 1 has the function of accepting an input to be processed by the language processing unit 20.

The parameter learning unit 24 determines the use condition and using score of each of words that are in the user dictionary stored in the user dictionary storing unit 32 and are usable when processing the input, based on the correct-incorrect judgments and the sentences stored with the respective words.

The determination is made in the same way as with the parameter learning unit 24 of the first exemplary embodiment (during user dictionary registration).

The language processing unit 20 is a part that applies processing to the input by using the language processing knowledge storing unit 31 and the user dictionary in the user dictionary storing unit 32.

The language processing unit 20 and the language processing knowledge stored in the language processing knowledge storing unit 31 are preferably the same as the language processing unit 20 and the language processing knowledge stored in the language processing knowledge storing unit 31 that are used by the user dictionary registration system of the present invention when creating the user dictionary that is stored in the user dictionary storing unit 32.

When using the words in the user dictionary for processing, the language processing unit 20 characteristically performs the processing by using the use conditions and using scores obtained by the parameter learning unit 24.

The terms “use condition” and “using score” employed here have the same meanings as described previously.

The output apparatus 4 has the function of outputting the result of processing of the language processing unit 20.

Next, the overall operation of the present exemplary embodiment will be described in detail.

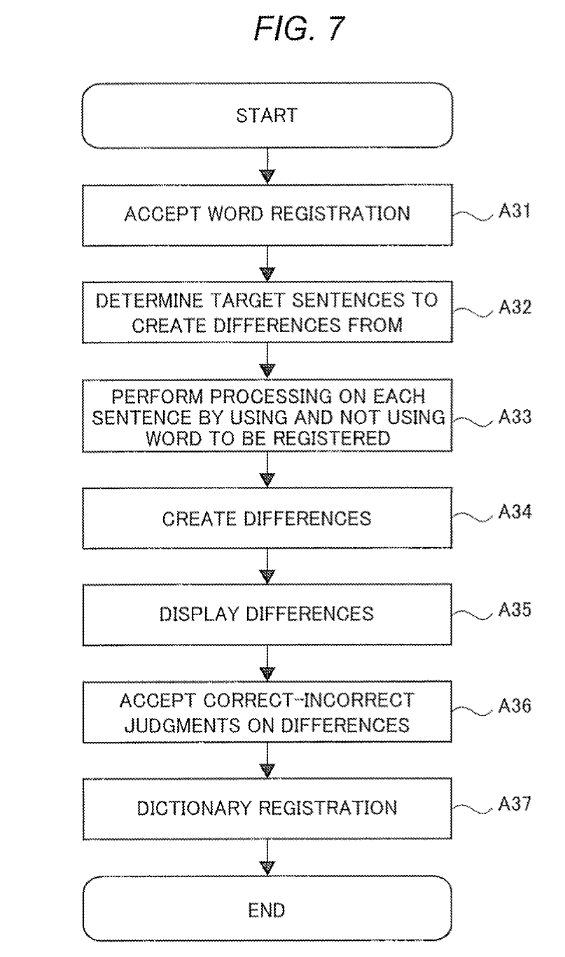

Firstly, the operation of the present exemplary embodiment when performing user dictionary registration will be described with reference to FIG. 5 and the flowchart of FIG. 7.

Note that steps A31 to A36 of the present exemplary embodiment are the same as steps A1 to A6 of the first exemplary embodiment illustrated in FIG. 3 (during user dictionary registration).

The registration information accepting unit 21 initially accepts registration information including the headword of a word to be registered in the user dictionary and its part of speech, translation, and meaning information from a user (step A31 in FIG. 7).

Next, the difference creating unit 21 determines a target document to create differences from (step A32).

The natural language processing unit 20 then creates the result of processing when each sentence in the target document is processed without the word accepted at step A31 being temporarily registered in the user dictionary, and the result of processing when each sentence is processed with the word temporarily registered in the user dictionary (step A33). For the temporary registration, parameters calculated by the parameter learning unit will not be granted. That is, the word is used as usual without a use condition granted or a using score changed.

Next, the difference creating unit 21 creates differences between the two results of processing obtained (step A34), and presents the differences to the user (step A35).

The correct-incorrect accepting unit 23 accepts a correct-incorrect judgment from the user as to each of the differences presented at step A5, whether the result of analysis changes to a correct one or incorrect one when the word is used as compared to when not (step A36).

Finally, the dictionary registration unit 25 registers the registration information accepted at step A31 into the user dictionary stored in the user dictionary storing unit 32, along with part or all of the pairs of the correct-incorrect judgments and the sentences from which the differences given the correct-incorrect judgments are created (step A37).

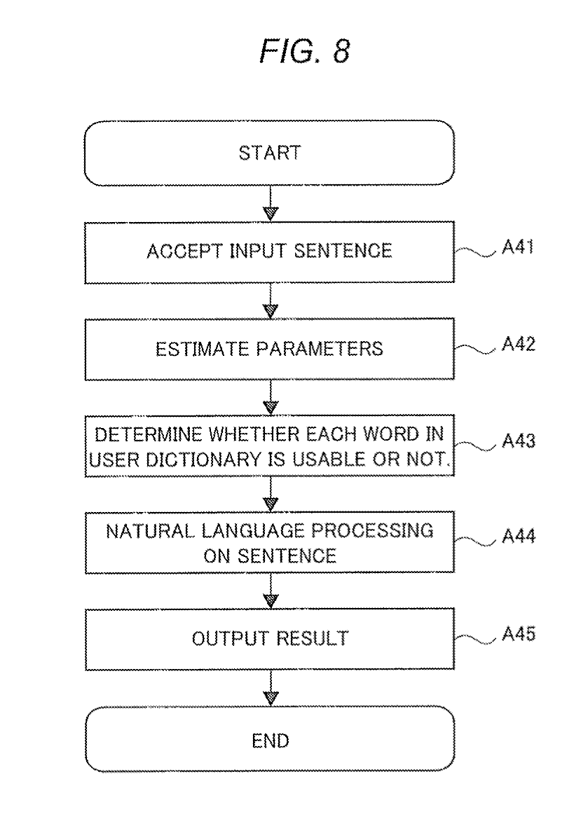

Secondly, the operation of the present exemplary embodiment during analysis will be described with reference to FIG. 2 and the flowcharts of FIGS. 6 and 8.

Note that steps A41, A43, A44, and A45 of the present exemplary embodiment are the same as steps A1, A2, A3, and. A4 of the first exemplary embodiment (during analysis using the use dictionary) illustrated in FIG. 4.

Initially, the input apparatus 1 accepts an input sentence to be processed (step A41 in FIG. 8).

Next, the parameter learning unit 24 determines the use condition and using score of each of words that are in the user dictionary stored in the user dictionary storing unit 32 and are usable when processing the input sentence, based on pairs of sentences and correct-incorrect judgments that are stored with the respective words (step A42).

When the word is used as'an ambiguity of the input sentence, the language processing unit 20 then determines whether the word is usable or not based on if the location of occurrence of the word in the sentence satisfies the use condition that is determined of the word at step A42 (step A43).

If the word in the user dictionary is determined to be usable, the word will be used in the language processing of subsequent stages. If the word in the user dictionary is determined to be unusable, on the other hand, the word will not be used in the language processing of the subsequent stages.

The language processing unit 20 further processes the input sentence (step A44).

When the processing uses a word in the user dictionary, the language processing unit 20 adjusts the score of validity of the ambiguity in the processing that uses the word, by adding the using score of the word determined at step A42 to the score of validity each time the word appears in the input sentence.

The result of processing that maximizes the validity score is then output from the language processing unit 20.

Finally, the output apparatus 4 outputs the result of processing that is output from the language processing unit 20 (step A45).

Next, the effects of the present exemplary embodiment will be described.

Like the first exemplary embodiment, the present configuration can display differences that are created by the difference creating unit, the differences occurring in the result of analysis of the language processing unit depending on if the word to be registered is used or not.

For each of the differences displayed, the user can make a judgment as to whether the result of analysis changes to a correct one or incorrect one due to the use of the word.

Based on the correct-incorrect judgments, such a condition as to use the word to be registered can be learned from peripheral information and the like of the word to be registered in cases where the user judges that the result of analysis changes to a correct one, and such a condition as not to use the word in cases where the user judges that the result of analysis changes to an incorrect one.

It is also possible to estimate such a using score of the word that enables the same discrimination, and register the using score in the user dictionary along with the registration information on the word.

The condition and the score obtained thus are used to perform analysis processing, so that the use of the word is suppressed if an input to a language processing unit is similar to that of the case where the user has judged that there occurs an incorrect change. This makes it possible to suppress adverse effects from the word registered.

In the present configuration, the word is recorded not with its use condition and using score themselves but with correct-incorrect judgments and target sentences for the use condition and using score to be determined from. As a result, in such cases that there appears a sentence where the word is used in a different way than assumed by the user after the registration of the word in the user dictionary, the user can adjust the use condition and using score of the word by adding correct-incorrect judgments and target sentences.

The foregoing exemplary embodiments have dealt with the cases where the use condition and using score of a word in the user dictionary, and the correct-incorrect judgments made by the user and the target sentences, are recorded exclusively of each other. The foregoing effects are also available, however, from an exemplary embodiment where such items are recorded together.

### Example 1

Next, the operation of the best modes for carrying out the present invention will be described in conjunction with specific examples.

Description will initially be given of a first example of the first exemplary embodiment. The first example deals with the case where the user dictionary registration system of the present invention is a user dictionary registration system for a Japanese-to-English machine translation system that translates Japanese into English.

In such a case, the language processing unit 20 functions as a Japanese-to-English machine translation unit that translates Japanese into English.

The language processing knowledge stored in the language processing knowledge storing unit 31 includes a Japanese-to-English translation dictionary (hereinafter, referred to as system dictionary) that describes bilingual relationships between Japanese words and English words intended for Japanese-to-English machine translation, and translation rules for transforming Japanese sentences into English sentences by using the dictionary.

Meanwhile, the user dictionary stored in the user dictionary storing unit 32 is a dictionary in which the user personally defines bilingual relationships between Japanese words and English words that are not described in the system dictionary.

The use condition of a word for the parameter learning unit to determine may be:

1) A condition that includes one or a combination of a headword, part of speech, conjugations, meaning classification, and other grammatical information on the word or a word lying in the vicinity of the word;

2) A condition as to whether the number of unknown words included in the result of morphological analysis increases or decreases depending on if the word is used or not;

3) A condition as to whether the success or failure of syntactic analysis depends on if the word is used or not;

4) A condition as to whether the morpheme boundary or part of speech of a word lying in the vicinity of the word varies depending on if the word is used or not;

5) A condition as to whether the segmentation of a phrase that contains the word varies depending on if the word is used or not; and

6) A condition as to whether the destination of reference in the result of syntactic analysis of a word lying in the vicinity of the word varies depending on if the word is used or not.

The use condition preferably includes a condition that is determined by one or a combination of the foregoing six conditions. It should be appreciated that other use conditions based on the correct-incorrect judgments accepted by the correct-incorrect accepting unit 23 may be used. Other use conditions and the foregoing six conditions may be used in combination.

The foregoing condition 2), whether the number of unknown words included in the result of morphological analysis increases or decrease and whether the success or failure of syntactic analysis depends are employed as the use condition for the following reason: such a change in analysis as increases unknown words and such a change in analysis as results in a failure of syntactic analysis are highly likely to be erroneous, and those conditions can reject unmistakable errors.

The foregoing condition 4), whether the morpheme boundary and part of speech of a peripheral word varies, the foregoing condition 5), whether the phrase segmentation varies, and the foregoing condition 6), whether the destination of reference in the result of syntactic analysis varies, are employed as the use condition for the following reason: when such items do not vary, changes in the result of processing of the language processing unit 20 are typically smaller and thus produce less adverse effects than when the items vary.

Using such variations as a condition often enables the isolation of adverse effects, and it is therefore preferable to use the foregoing six conditions.

If the use condition is not appropriately definable by the foregoing conditions alone, headwords, parts of speech, conjugations, meaning classifications, and other grammatical information on the periphery of the word may also be used for the use condition.

Now, let us consider the case where the Japanese-to-English machine translation system is used to translate the sentence [symbol] [symbol] Suppose that the translation fails because the proper noun [symbol] has not been registered in the system dictionary, and the user is going to register the proper noun [symbol] in the user dictionary.

Initially, the registration information accepting unit 21 accepts information necessary for registering [symbol] in the user dictionary.

Since the intended natural language processing of the present example is Japanese-to-English machine translation, the following information necessary for registration is input:

Headword: [symbol] part of speech: proper noun; translation; Kanda; part of speech of translation: NOUN; meaning classification: person. Note that the type of the registration information represented here is illustrative, and may differ depending on the type and the method of implementation of the intended natural language processing.

For example, the translation information is unnecessary in other than a translation dictionary. Pronunciation and accent information are needed in a dictionary for speech synthesis.

Next, the difference creating unit 22 creates differences in the result of processing of the language processing unit 20 between when the registration information accepted is used and when not.

For that purpose, a set of sentences for differences to be created from need to be defined. Such a set may be prepared in advance, may be specified by the user at the time of registration, or may be dynamically retrieved and acquired from a location where large amounts of documents are stored, such as the Internet and a document management server.

The usage of a word often varies depending on the field in which the word is used.

For the sake of accurate parameter learning in the subsequent stage, the set of sentences preferably are ones that are used in the field to which the user frequently applies the natural language processing system.

For the purpose of reducing the processing time, the set is preferably limited to sentences that contain the character string of the headword of the word that is currently to be registered, or the character string of a conjugation of the word if the word has any conjugation such as a continuative form and a terminal form.

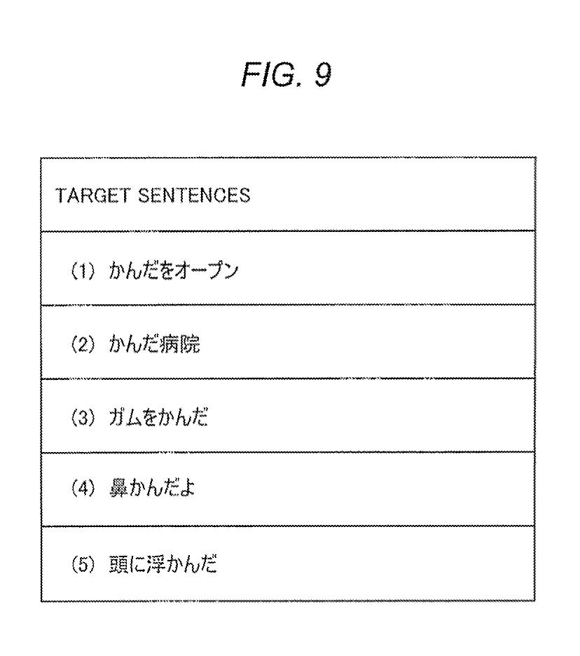

The following description will be given on the assumption that the set of sentences determined thus consists of the five sentences illustrated in FIG. 9.

Next, the results of processing on each of the five sentences in the set are determined for when the processing is performed without using the word [symbol] ” currently to be registered and when the processing is performed with the word temporarily registered in the user dictionary.

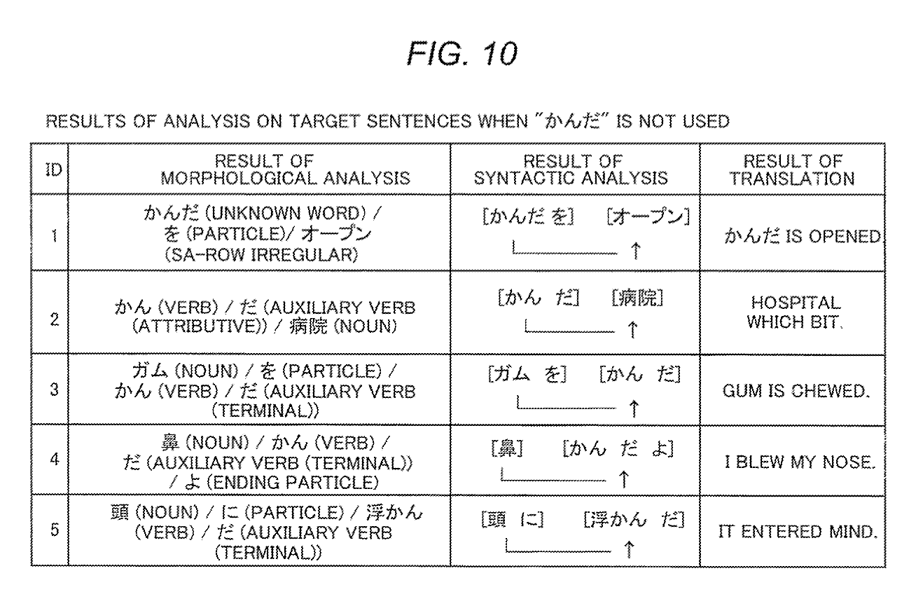

FIG. 10 illustrates the result of morphological analysis, the result of syntactic analysis, and the result of translation or the output of the language processing unit 20 on each of the sentences of FIG. 9 without using the word

[symbol]

In the result of morphological analysis, “/” indicates a word boundary, and the parentheses “( )” represent the part of speech or conjugation of the word. In the result of syntactic analysis, the square brackets “[ ]” indicate a phrase block, and the arrow indicates the destination of reference of the phrase.

Take the sentence ID I as an example. As a result of morphological analysis, the sentence [symbol] [symbol] is divided into three words [symbol] and “ [symbol] with parts of speech “unknown word”, “particle”, and “sa-row irregular”, respectively.

By syntactic analysis, two words [symbol] and [symbol] are grouped into a phrase, and one word [symbol] another phrase. The phrase consisting of [symbol] and [symbol] is referentially destined for the phrase consisting of [symbol] The result of translation is [symbol] is opened.”

If a part of speech in the result of morphological analysis is followed by additional parentheses “( )”, the content of the parentheses indicates the conjugation of the conjugated word.

Take the sentence ID5 as an example. The last morpheme [symbol] in the result of morphological analysis has a part of speech “auxiliary verb” with a conjugation “terminal”.

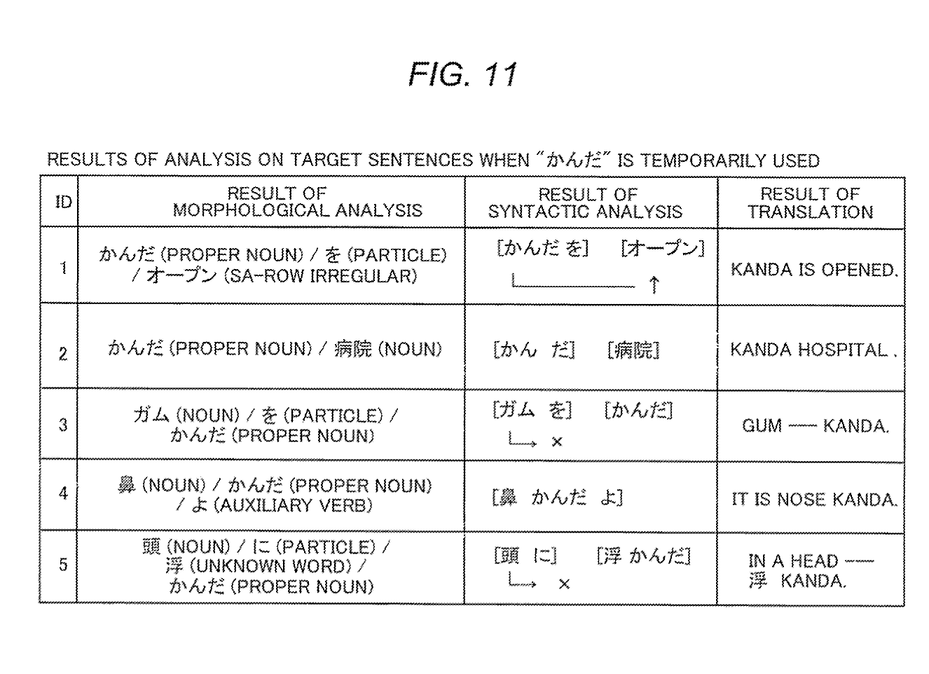

Now, FIG. 11 illustrates the result of morphological analysis, the result of syntactic analysis, and the result of translation or the output of the language processing unit 20 on each of the sentences of FIG. 9 when the word [symbol] is temporarily registered in the user dictionary and the word is used for processing. In the result of syntactic analysis, the arrow for indicating the destination of reference ends in “x” to indicate that the destination of reference is indeterminable.

For example, in the sentence of the sentence ID3, the phrase consisting of [symbol] and [symbol] has no destination of reference determined. In the sentence ID5, the phrase consisting of [symbol] and [symbol] has no destination of reference determined.

In the present example, the processing of syntactic analysis starts with phrasing before calculating the destination of reference of each phrase. However, words to be the destinations of reference of the respective words may be directly calculated Without phrasing. In such cases, no phrase-related features will be used.

Here, the result of processing of the language unit 20 is obtained along with its intermediate states, i.e., the result of morphological analysis and the result of syntactic analysis. While the result of morphological analysis is indispensable in the present invention, the processing of syntactic analysis may be omitted depending on the type of the language processing unit 20. If the present invention is applied in order to perform language processing that includes no such processing of syntactic analysis, it is not necessarily needed to determine the result of syntactic analysis.

Even if the result of syntactic analysis is not used, the effect of suppressing adverse effects from user dictionary registration, which is the purpose of the present invention, can be achieved but with as much decrease in effectiveness as the disuse of the information on the result of syntactic analysis.

If the present invention is applied to a language processing apparatus 20 that does not perform the processing of syntactic analysis, on the other hand, an additional syntactic analysis unit may be provided to obtain the result of syntactic analysis. The result can be taken into the user dictionary registration system of the present invention to enhance the effect of the present invention.

Next, the difference creating unit 22 creates and displays differences between the two types of results of processing of the language processing unit 20, i.e., the results of translation.

In a preferred method, the differences are displayed for only such sentences that produce differences in the result of translation between when the word to be registered is used and when not, such that the original sentence, the result of translation not using the word, and the result of translation using the word are arranged and displayed three in a group.

More preferably, character strings that actually make the differences are displayed in a different color or highlighted with an underline or other markers in the two results of translation using and not using the word. This allows the user to check the differences more efficiently.

There is provided an interface that displays the group of three for all or part of the set of target sentences, and accepts a correct-incorrect judgment on each of the differences as to whether the result of analysis changes to a correct one or incorrect one when the word is used as compared to when not.

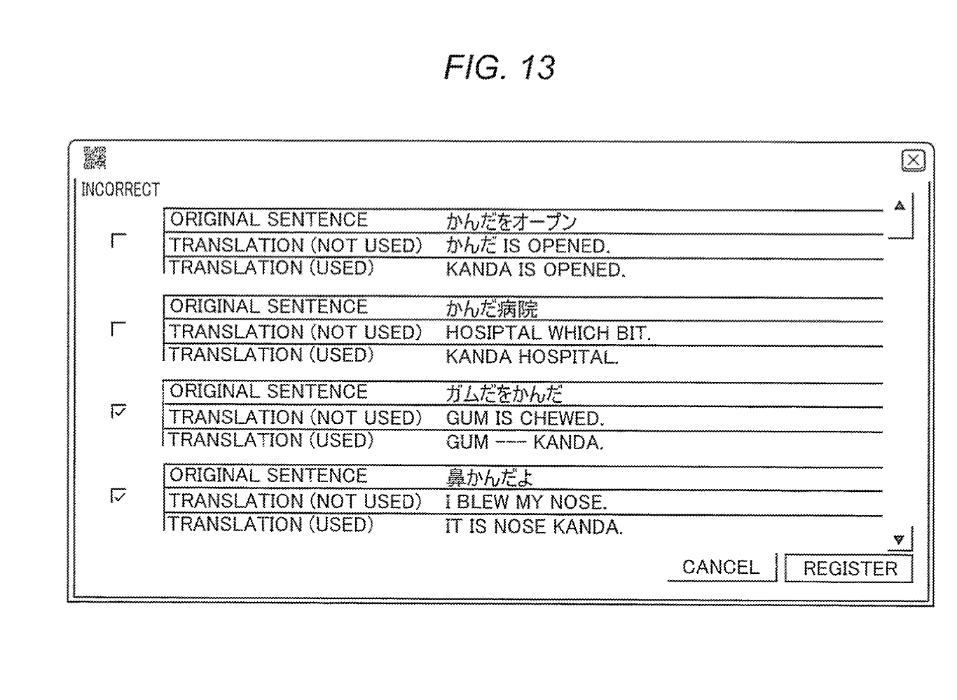

FIG. 13 illustrates an example of the foregoing method of displaying differences. A single sentence can sometimes produce a plurality of differences which may be correct or incorrect independently of each other. The interface for accepting a correct-incorrect judgment may thus be configured to accept a judgment on each of the locations of the differences in a sentence.

Next, the correct-incorrect accepting unit 23 accepts a correct-incorrect judgment on each difference by using the differences displayed and the interface for accepting a correct-incorrect judgment. Suppose that the user inputs “correct” for the changes in the results of the sentences ID1 and ID2 because the results are improved by the temporary registration of the word, and the user inputs “incorrect” for the changes in the results of the sentences ID3 to ID5 because the results are deteriorated.

Based on the correct-incorrect judgments accepted and the results of morphological analysis and syntactic analysis determined for the cases where the word to be registered is used and where not, the correct-incorrect accepting unit 23 also extracts information (hereinafter, referred to as features) for determining the use condition of the word. Preferred examples of the features are as follows:

Increase of unknown words: the number of unknown words increased as compared to when the word is not used.

Increase of syntax failures: the number of undetermined destinations of reference increased as compared to when the word is not used.

Destination of reference: whether there is any phrase or word whose destination of reference varies depending on if the word is used or not. It is not limited whether a change of the unit (phrase or word) in which the destination of reference is considered should be counted as a change of the destination of reference. It is preferable to count a change of the right boundary of the unit as a change of the destination of reference.

Phrase boundary: whether the boundaries of phrases resulting from phrasing change or not.

Morpheme boundary: whether the boundaries of word segments resulting from morphological analysis change or not.

Conjugations: conjugations of the word if the word is conjugated. Conjugations may simply be extracted, or some abstraction may be made (such as grouping into two values continuative and attributive depending on whether the destination of reference is declinable or indeclinable).

Part of speech and conjugation of the original word: the part(s) of speech and conjugation(s) of a word or words that fall(s) on the position of the word in the result of morphological analysis when the word is not used. If two morpheme boundaries that the word forms when the word is used remain unchanged as compared to when the word is not used, the part(s) of speech and conjugation(s) of a word or words that adjoin(s) to the two morpheme boundaries from inside. There is no limitation as to a definition for the case where the morpheme boundaries vary, whereas null (no value) is preferably used.

Part of speech and conjugation of adjoining word: the part(s) of speech and conjugations of words that adjoin to the right and left of the word in the result of morphological analysis when the word is used. There is no limitation as to a definition for the case where the word lies at the beginning or end of the sentence, whereas the word adjoining to the left shall preferably have a part of speech “beginning of sentence” and the word adjoining to the right a part of speech “end of sentence”.

While the grammatical information on the periphery of words that lie in the vicinity of the word is exemplified by only the parts of speech and conjugations of the original word and adjoining words, the range of reference is not limited to the exemplified range. If the use condition is not definable from the foregoing features alone, information on the character string (headword) of the word may also be used.

The types of the grammatical information to be used are not limited to the aforementioned ones, either, and may include other information such as meaning classifications, conjugations if the word is conjugated, and various information if the word is declinable.

A set of features that accompany a single correct-incorrect judgment will be referred to as “instance”.

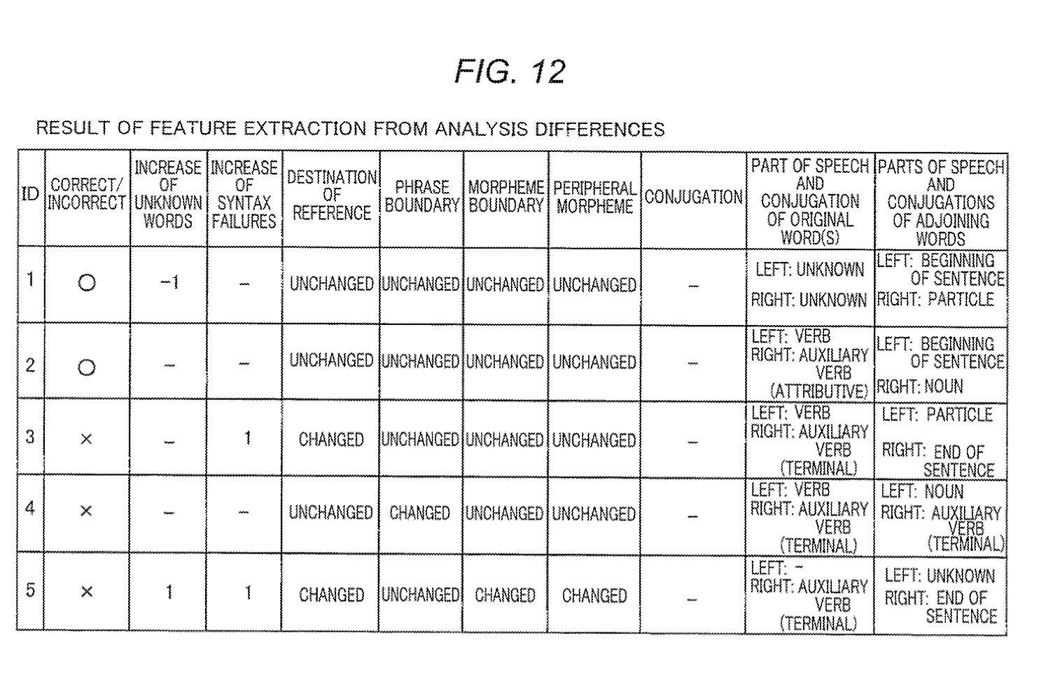

FIG. 12 illustrates a summarized table of the features obtained from the target sentences currently to be processed and correct-incorrect judgments input by the user. For a concrete example, description will be given of the result of extraction of features from the sentence ID3.

For the sentence ID3, the user has made an input “incorrect”, and the correct-incorrect judgment is thus “x”.

The number of unknown words in the result of morphological analysis is 0 irrespective of whether the word is used or not. The increase of unknown words is thus 0−0=“-(unchanged)”.

The number of undetermined destinations of reference in the result of syntactic analysis is 0 when the word is not used, and 1 when used. The increase of syntax failures is thus 1−0=“ 1”.

With the morpheme boundaries of the word indicated by “/”, the sentence is [symbol] [symbol] Such boundaries are intactly included in the morpheme boundaries for the case where the word is not used, or [symbol] [symbol] [symbol] The morpheme boundaries are thus “unchanged”.

The morphemes before and after [symbol] are [symbol] (particle) and “end of sentence”, which remain unchanged irrespective of whether the word is used or not. The peripheral morphemes are thus “unchanged”.

The phrase boundaries are “unchanged” since the phrases resulting from phrasing remain unchanged irrespective of whether the word is used or not.

The destination of reference is “changed” since the destination of reference of the phrase [symbol] becomes undetermined when the word is used.

The conjugations are “-(null)” since the word is neither a conjugated word nor a particle.

The morpheme boundaries remain unchanged irrespective of whether the word is used or not. When the word is not used, there are two words [symbol] (verb)/ [symbol] (auxiliary verb (terminal))” in the position of the word. Thus, the part of speech and conjugation of the original word that adjoins to the left morpheme boundary are [symbol] (verb)”. The part of speech and conjugation of the original word that adjoins to the right morpheme boundary are [symbol] (auxiliary verb (terminal))”.

When the word is used, the word that adjoins to the left of the word is [symbol] (particle)”. The part of speech and conjugation of the word adjoining to the left is thus “particle (no conjugation)”. Since the word is at the end of the sentence, the part of speech and conjugation of the word adjoining to the right is “end of sentence (no conjugation)”.

Based on the features obtained thus, conditions that enable appropriate correct-incorrect judgments are determined. As employed herein, being appropriate means that the determined conditions are capable of making proper judgments, preferably as to all the correct-incorrect judgments given by the user, based on the features obtained.

Note that whether correct or incorrect is not always fully determinable. In such cases, the conditions are preferably determined so that instances that are actually “incorrect” can be properly judged to be “incorrect” as many as possible in order to minimize the adverse effects from the registration of the word, even though some instances that are supposed to be “correct” can be erroneously judged to be “incorrect”.

The judgment conditions may be obtained by learning using a classifier such as SVM (Support Vector Machine). The conditions may also be determined by heuristic techniques of some kind.

Hereinafter, an example of a method for a heuristic approach will be described.

The heuristic method described below is to ease the problem of overtraining which can easily occur in a learning machine such as SVM when instances to be learned are small in number.

In the method described in the present example, features are heuristically ranked in advance in descending order of the capability to make a correct-incorrect judgment. The features are also classified into a plurality of classes of ranks, so that the features of lower classes will not be used if a judgment can be made with the features of higher classes alone. In order to determine a use condition more appropriately even with a small number of instances given to the parameter learning unit 24, conditions that are based on the features of high classes of judgment capability are maintained even if a judgment can be made with the features of even higher classes alone.

On the other hand, conditions that are based on the features of intermediate and low classes of judgment capability can cause overtraining. Such features are therefore not used for conditions if a judgment can be made with the features of higher classes alone.

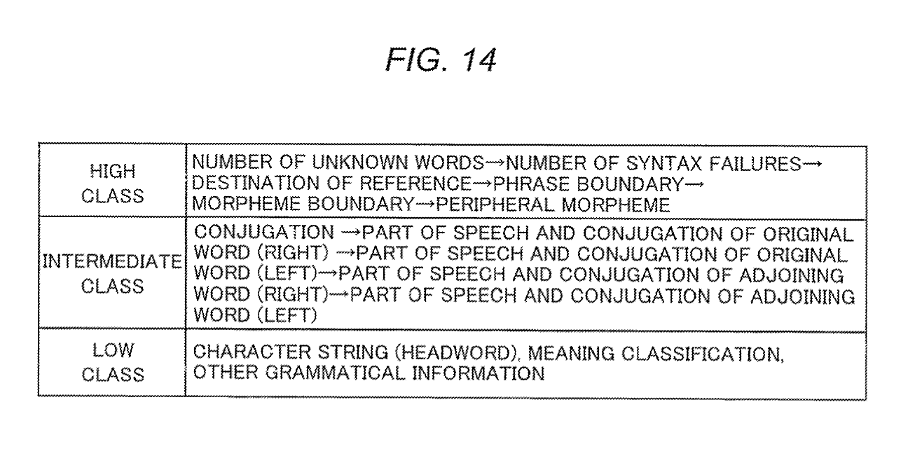

FIG. 14 illustrates an example of the definitions based on the foregoing policies. In each of the classes in FIG. 14, features lying at the upper reaches of the arrows have higher priority.

The processing of condition acquisition will actually be described in conjunction with a specific example.

Initially, conditions are determined by using the features of the high class. The following lists the conditions of which a correct-incorrect judgment can be made accurately. The conditions shall not include null (−).

There are four conditions that have extremely high reliability, “increase of unknown words <0→o”, “decrease of unknown words >0→x”, “increase of syntax failures <0→o”, and “increase of syntax failures >0→x”. Such conditions are listed as elements of the use condition unless there is any instance that does not satisfy the conditions.

The conditions to be listed based on the specific example of the present example are as follows:

Increase of unknown words <0→o, increase of unknown words >0→x; Syntax failure <0→o, increase of syntax failures >0→x; Destination of reference=changed→x; Morpheme boundary=changed→x; and Peripheral morpheme=changed→x. The conditions are connected into a use condition according to the ranking of the features:

if (increase of unknown words <0) then o else if (increase of unknown words >0) then x else if (syntax failures <0) then c else if (syntax failures >0) then x else if (destination of reference=changed) then x else if (morpheme boundary=changed) then x else if (peripheral morpheme=changed) then x. Such a use condition is fully capable of making a correct-incorrect judgment on the five given instances. The use condition is thus used as that of the word [symbol] [symbol] to be registered. If the foregoing conditions are insufficient to make a correct-incorrect judgment on the five given instances, the features of the intermediate class are used to provide detailed conditions. If still insufficient, the low class are used further.

It should be appreciated that a use condition may be determined with correct-incorrect judgments still insufficient. For example, the features that are classified in the low class here, such as the headword of the word, are generally likely to cause overtraining. When the number of instances is small, such features are preferably left unused even if correct-incorrect judgments are insufficient.

Finally, the dictionary registration unit 25 registers the registration information accepted by the registration information accepting unit 21 into the user dictionary in the user dictionary storing unit 22 along with the use condition obtained as described above.

This is the end of the concrete description of the processing for registering a word in the user dictionary. Hereinafter, description will be given of Japanese-to-English machine translation processing using entries that are registered in the user dictionary as described above, in conjunction with specific examples.

Suppose that an input [symbol] [symbol] is given to the Japanese-to-English translation system. The system performs a morphological analysis on the input by using the words in the user dictionary. The result of morphological analysis is as follows:

[symbol] (proper noun)/ [symbol] (suffix) / [symbol] (particle)/ [symbol] (verb (terminal)). It can be seen that the word [symbol] in the user dictionary is in use. The system then calculates the result of morphological analysis and the result of syntactic analysis when [symbol] registered in the user dictionary is used, and the result of morphological analysis and the result of syntactic analysis when not.

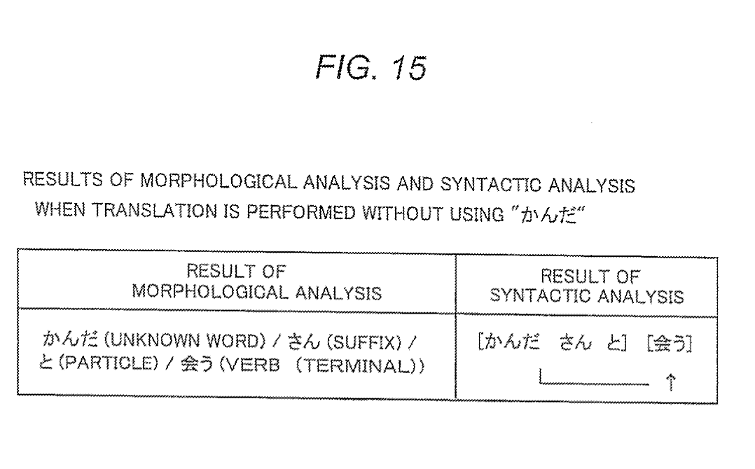

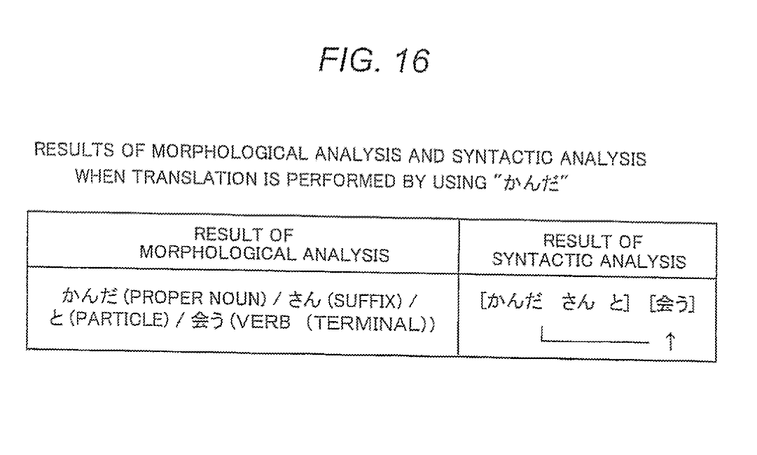

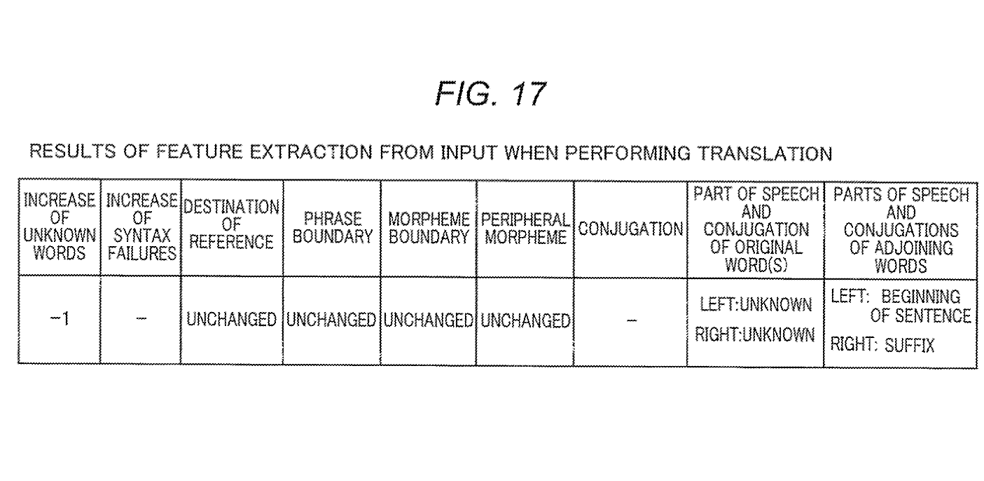

FIGS. 15 and 16 illustrate the results of analysis. From the results of analysis, features are extracted simultaneously with user dictionary registration. FIG. 17 illustrates the result of extraction.

Let us refer to the use condition that is registered with the word [symbol] in the user dictionary. Among the features extracted, the feature “increase of unknown words=−1” matches with the section “if (increase of unknown words <0) then o”, so that the judgment is thus “o”. For such an input, the word [symbol] in the user dictionary is thus used to obtain a natural translation “I will meet Mr. Kanda.”

Now, suppose that an input [symbol] is made to the system. The word “ [symbol] in the user dictionary may be used again, whereas the increase of syntax failures increases when the word is not used as compared to when used. This matches with the section “else if (syntax failures >0) then x” of the use condition that is recorded with the word [symbol] and the word [symbol] is therefore not used. As a result, the use of the word [symbol] is appropriately suppressed to obtain a natural translation “I bit my tongue.”

This is the end of the description of the concrete example with the word [symbol] Next, brief description will be given of a concrete example with the word

[symbol]

[symbol]

As with [symbol] the registration information accepting unit 21 initially accepts registration information on

[symbol]

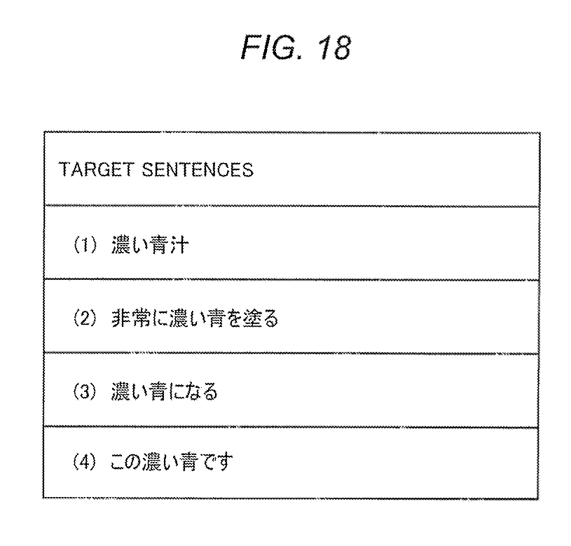

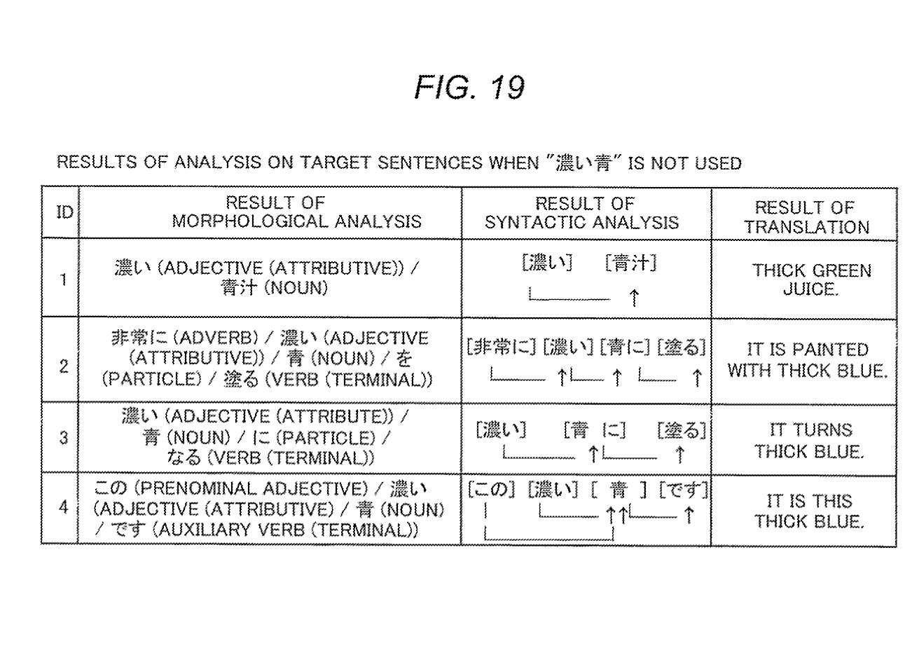

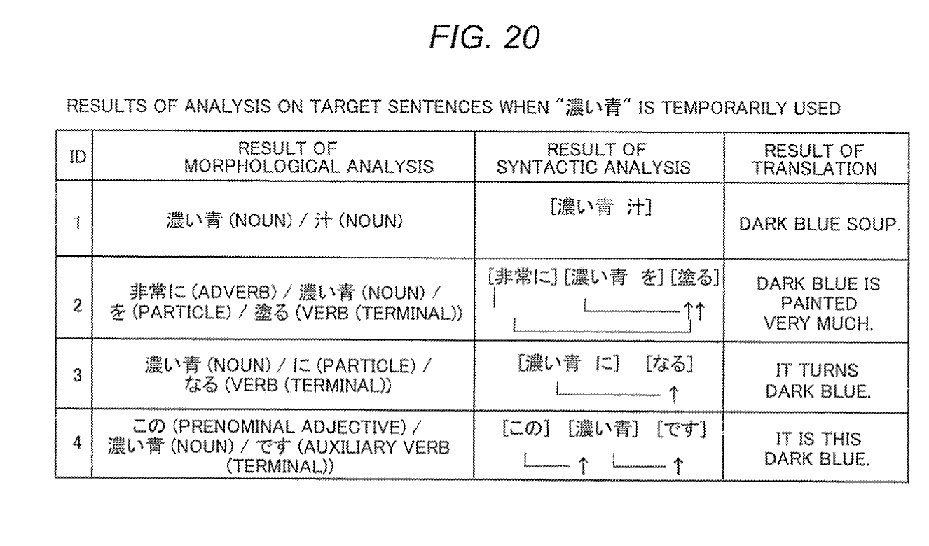

Headword: [symbol] part of speech: noun; translation: dark blue; part of speech of the translation: NOUN. The set of sentences intended for difference creation, the results of morphological analysis and syntactic analysis, and the features obtained shall be as illustrated in FIGS. 18, 19, 20, and 21. As with [symbol] the following use condition is obtained.

if (unknown word increase <0) then o else if (unknown word increase >0) then x else if (syntax failures <0) then c else if (syntax failures >0) then x else if (destination of reference=changed) then x else if (morpheme boundary=changed) then x else if (peripheral morpheme=changed) then x The use condition is registered in the user dictionary along with the foregoing registration information. Then, Japanese-to-English translation processing is performed by using the user dictionary. Such inputs as [symbol] and “ [symbol] ” satisfy the use condition that is registered with the word [symbol] [symbol] so that respective appropriate translations using the registered word, “I like dark blue” and “a dark blue shirt”, are output.

For such inputs as [symbol] [symbol] and [symbol] the use of the word would result in incorrect translations with corrupted sentence structure like “This is—very—dark blue.” and “a dark blue sky of color”. Since the inputs match with the conditions “destination of reference =changed” and “morpheme boundary=changed”, respectively, the use condition of the word is not satisfied and there are output the results of translation not using the word, “This is thick blue.” and “a blue sky with thick color”.

This is the end of the description of the concrete example with the word [symbol] Next, a method of using the using score instead of the use condition will be described briefly.

In the foregoing concrete examples, whether or not to use the word registered in the user dictionary has been determined by using feature-based conditions. However, some of the conditions may be implemented by adjusting the using score.

Take, for example, the case of registering the word [symbol] which means New Year's spiced sake. If the word is not registered, such a sentence as [symbol] [symbol] results in a failed translation. Typically, words in small numbers of Hiragana characters, and ones starting or ending with characters that coincide with particles in particular, often have serious adverse effects. The word [symbol] meets such a condition. In fact, the registration of [symbol] can corrupt the interpretation of [symbol] etc.

With the use-condition based method, the following condition shall be provided when it is evident from the result of accepting of correct-incorrect judgments and parameter learning that the analysis fails unless the word is used.

if (unknown word increase<0) then o else if (unknown word increase>0) then x else if (syntax failures<0) then c else if (syntax failures>0) then Such a condition where the word is used only if the analysis would fail evidently is an example of the condition that can be implemented by adjusting the using score.

The words in the user dictionary typically have priority over those in the system dictionary. That is, the words in the user dictionary are given using scores of higher priorities than those of the scores of the words in the system dictionary. If a word is to be used only when the analysis would fail evidently, appropriate use control can be implemented by giving the word a using score that has a priority lower than that of the use conditions of the words in the system dictionary and higher than that of the creation of an unknown word.

Another applicable example will be described in conjunction with a specific example where the foregoing word [symbol] is registered. Suppose that two ambiguities [symbol] and [symbol] have substantially the same interpretation validity (score) since both the ambiguities are made of two independent words.

Here, it may be needed in order to judge the result of accepting of correct-incorrect judgments to implement such a use control as uses other ambiguities having substantially the same validity, if any, without using the word

[symbol]

Even in such cases, a solution can be provided by setting the using score to a priority lower than that of the using scores of the words in the system dictionary.

It should be appreciated that the feature-based conditions and the using score-based control are not exclusive of each other. Parameter learning may be performed so as to exercise both at the same time.

Now, description will be given of the effect of the use of the first example. When an ordinary Japanese-to-English machine translation system was used to translate a sentence [symbol] [symbol] the translation failed since the proper noun [symbol] was not registered in the dictionary. The user then registered the proper noun [symbol] so that the translation system successfully provided a correct translation of the sentence. Meanwhile, a sentence [symbol] [symbol] was interpreted such that [symbol] was a proper noun, and a correct translation was not made successfully. If [symbol] was not registered, on the other hand, such expressions as [symbol] [symbol] and [symbol] failed to be translated correctly.

According to the dictionary registration system of the present invention, the correct-incorrect accepting unit 23 makes the user input a correct-incorrect judgment on each example sentence as to the use of a word to be registered. From the correct-incorrect judgments, the parameter learning unit 24 determines the use condition and using score of the word, which can be referred to during the actual processing of the language processing unit 20. This makes it possible to register the word in the user dictionary while suppressing adverse effects from the registration of the word if any.

The word [symbol] which has had adverse effects when registered by the user dictionary registration systems of the related technologies, can also be registered with the adverse effects suppressed.

### Example 2

Next, description will be given of a second example according to the second exemplary embodiment. The second example also deals with the case where the user dictionary registration system of the present invention is a user dictionary registration system for use in a Japanese-to-English machine translation system which translates Japanese into English.

The language processing unit 20, the language processing knowledge storing unit 31, and the user dictionary storing unit 32 are the same as in the first example. There is a difference in that the information to be registered in the user dictionary in the user dictionary storing unit 32 along with a word includes correct-incorrect judgments that the correct-incorrect accepting unit 23 accepts from the user and input sentences from which differences given the respective correct-incorrect judgments are created.

As in the first example, let us consider the case of registering

[symbol]

The registration information accepting unit 21 initially accepts the same registration information as in the first example.

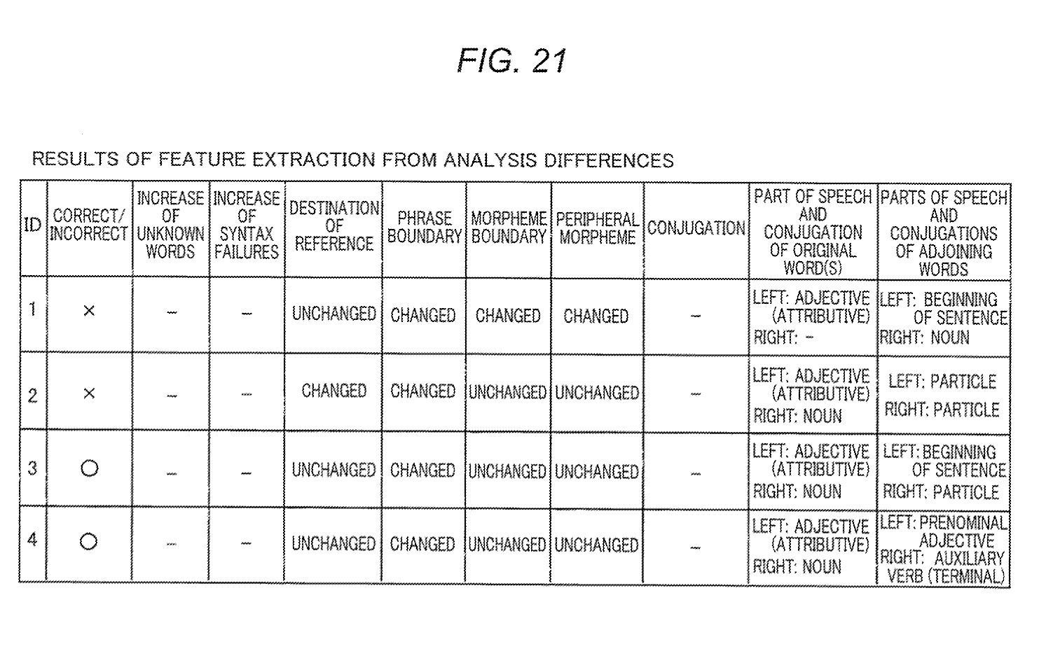

Suppose that, unlike the first example, the difference creating unit 22 selects only the sentences (2) to (4) of FIG. 18 as the target sentences to create differences from. For the differences created from the target sentences selected, the user shall input the same correct-incorrect judgments as in the first example from the correct-incorrect accepting unit 23 (whereby the correct-incorrect judgments on ID2 to ID4 of FIG. 21 are obtained).

Finally, the dictionary registration unit 25 registers the foregoing registration information in the user dictionary along with the correct-incorrect judgments obtained and the target sentences from which the differences given the respective correct-incorrect judgments are created. That is, the following information is registered with the registration information: [symbol] [symbol] →x; [symbol] →o; and [symbol] →o. This is the end of the description of the processing for registering a word in the user dictionary. Hereinafter, description will be given of Japanese-to-English machine translation processing using the entries that are registered in the user dictionary as described above, in conjunction with specific examples.

Suppose that an input [symbol] [symbol] is given to the Japanese-to-English machine translation system. In the system, the parameter learning unit 24 performs a morphological analysis on the input by using the words in the user dictionary. The result of morphological analysis is as follows: [symbol] (noun)/ [symbol] (particle)/ [symbol] (adverb)/ [symbol] (noun)/ [symbol] (auxiliary verb).

This represents that the word [symbol] in the user dictionary can be used. Then, the parameter learning unit 24 subsequently performs a morphological analysis and syntactic analysis using the word, and performs a morphological analysis and syntactic analysis not using the word, on the target sentences that are registered with the word [symbol] and from which the differences given the correct-incorrect judgments have been created.

The parameter learning unit 24 extracts features intended for parameter learning from the results in the same way as the parameter learning unit 24 of the first example does. The results of extraction are the same as ID2 to ID4 of FIG. 21. Based on the results, the parameter learning unit 24 obtains a use condition in the same way as the parameter learning unit 24 of the first example does. The use condition obtained is as follows:

if (unknown word increase <0) then o else if (unknown word increase >0) then x else if (syntax failures <0) then c else if (syntax failures >0) then x else if (destination of reference=changed) then x. The input made to the Japanese-to-English translation system is subjected to a morphological analysis and syntactic analysis using the word and not using the word, whereby features are extracted to determine whether the use condition is satisfied or not. Since the condition “destination of reference=changed” is met, the use condition is not satisfied. In consequence, the use of the word [symbol] is properly suppressed.

Meanwhile, such inputs as [symbol] [symbol] and [symbol] [symbol] satisfy the foregoing use condition, and the word [symbol] is used appropriately. It is represented that the system operates to register the adversely-affecting word and suppress the adverse effects as in the first example.

Now, suppose that there is made an input [symbol] In such a case, using the word [symbol] produces an inappropriate translation “dark blue soup”, and it is therefore desirable to suppress the use of the word [symbol] In view of whether the use condition is satisfied or not, however, the use condition is actually satisfied and the word [symbol] would thus be used.

When the use condition has such insufficient accuracy, the sentence that causes the erroneous decision on the use condition and a correct-incorrect judgment on the sentence are added to the user dictionary. The additional judgment and sentence are combined with the correct-incorrect judgments and the target sentences of the judgments that have already been registered. In consequence, the correct-incorrect judgments and target sentences registered for the word [symbol] [symbol] are as follows: [symbol] [symbol] →x; [symbol] →o; [symbol] →o; and [symbol] →x (currently added). If the input [symbol] is accepted again in such a state, the use condition represented below will be obtained this time. Since the correct-incorrect judgments and the target sentences from which the use condition is acquired are the same as those of the first example, the use condition is the same as in the first example:

if (unknown word increase <0) then o else if (unknown word increase >0) then x else if (syntax failures <0) then c else if (syntax failures >0) then x else if (destination of reference=changed) then x else if (morpheme boundary=changed) then x else if (peripheral morpheme=changed) then x. The input [symbol] meets the condition “morpheme boundary=changed” this time, and therefore fails to satisfy the use condition. The use of the word [symbol] [symbol] can thus be suppressed to obtain an appropriate input “thick green soup.”

Now, description will be given of the effect of the invention according to the second example. As in the first example, a word that is difficult for an ordinary Japanese-to-English machine translation system to register can be registered in the user dictionary. Besides, the correct-incorrect judgments and target sentences from which the current use condition and using score are estimated can be registered in the user dictionary. Consequently, even if it is found afterward while using the Japanese-to-English machine translation system that the use condition and using score determined at the time of user dictionary registration are insufficient, it is possible to accept an additional target sentence and an additional correct-incorrect judgment thereon to estimate the use condition and using score again. This makes it possible to re-set a more appropriate use condition and using score.

In the foregoing examples, the use condition and using score of a word in the user dictionary, and the user's correct-incorrect judgments and the target sentences, are recorded exclusively of each other. The foregoing effects are also available, however, from an exemplary embodiment where such items are recorded together.

In the foregoing exemplary embodiments, the language processing unit 20 is exemplified by Japanese-to-English machine translation. However, the application of the present invention is not limited to Japanese-to-English machine translation.

The foregoing examples have also dealt with the cases where the dictionary registration system of the present invention is used when the user creates a user dictionary. However, the examples may be used for other applications. For example, when a developer of a language processing system constructs a system dictionary for the language processing system, the dictionary registration system of the present invention may be used to store the use conditions and using scores of the words, and the sentences and correct-incorrect judgments intended for parameter learning into the system dictionary.

In such a case, the use conditions and the like stored by the developer of the foregoing language processing system are consulted for processing when using the words in the system dictionary, as with the cases of using the words in the user dictionary which have been described in the foregoing examples.

The dictionary registration system may be implemented by hardware, software, or a combination of these.

The present application is based on Japanese Patent Application No. 2007-136660 (filed May 23, 2007), and claims a priority according to the Paris Convention based on the Japanese Patent Application No. 2007-136660. A disclosed content of the Japanese Patent Application No. 2007-136660 is incorporated in the specification of the present application by reference to the Japanese Patent Application No. 2007-136660.

The typical exemplary embodiments of the present invention have been described in detail. However, it is to be understood that various changes, substitutions, and alternatives can be made without departure from the spirit and the scope of the invention defined in the claims. Moreover, the inventor contemplates that an equivalent range of the claimed invention is kept even if the claims are amended in proceedings of the application.

### INDUSTRIAL APPLICABILITY

The present invention may be applied to an arbitrary system that performs processing after a morphological analysis of dividing a natural language sentence into words.

More specifically, the present invention is applicable to a user dictionary registration system for such systems as: a morphological analysis system; a syntactic analysis system that creates a relational structure between words from a natural language sentence; a speech synthesis system that synthesizes an input natural language sentence into speech for output; a machine translation system that translates an input natural language sentence into another language for output; and a mining system that extracts characteristic words, word co-occurrences, and word sequences from a large set of natural language sentences.

1. A dictionary registration system for performing natural language processing by using a user dictionary, the system comprising:
a data processing apparatus that performs the natural language processing by managing and using the user dictionary; and
a storage apparatus that retains system dictionary information and user dictionary information for use in the natural language processing,
wherein
said storage apparatus includes
the system dictionary information for use in the natural language processing, and
the user dictionary; and
said data processing apparatus includes
word information registering unit that registers information on an input word into the user dictionary,
a difference creating unit that creates differences in a result of processing between a first result of processing when the natural language processing is performed by using the system dictionary information and a second result of processing when the natural language processing is performed by using the system dictionary information and the user dictionary information,
a correct-incorrect accepting unit that accepts correct-incorrect judgments as to whether changes from the first result of processing to the second result of processing are correct or incorrect, the changes corresponding to the differences created by said difference creating unit, and
a dictionary registration unit that registers registration information on the accepted word into the user dictionary along with part or all of pairs of the correct-incorrect judgments accepted and input sentences from which the differences given the respective correct-incorrect judgments are created.

2. The dictionary registration system according to claim 1, wherein
said data processing apparatus further includes:
a parameter learning unit that calculates a use condition and a using score of the accepted word by using information on the pair(s) of the correct-incorrect judgment(s) and the input sentence(s) from which the difference(s) given the correct-incorrect judgment(s) is/are created, the pair(s) being stored with the word and registered in the user dictionary by said dictionary registration unit; and
a natural language analysis processing unit that, when an input to be analyzed by a natural language processing system includes a word that is registered in the user dictionary by said dictionary registration unit, analyzes the input by using the information on the input word registered by said word information registering unit only if the use condition of the word calculated by said parameter learning unit is satisfied, or analyzes the input by using the score calculated by said parameter learning unit.

3. The dictionary registration system according to claim 1, wherein
said data processing apparatus further includes
a use condition and using score recalculating unit that is capable of accepting an additional correct-incorrect judgment as to information on a pair of a target sentence of the registration information on the word accepted and an input sentence from which a difference given a correct-incorrect judgment is created, and recalculating the use condition and using score that are registered in the user dictionary by said dictionary registration unit.

4. A dictionary registration system for performing natural language processing by using a user dictionary, the system comprising;
a data processing apparatus that performs the natural language processing by managing and using the user dictionary and
a storage apparatus that retains system dictionary information and user dictionary information for use in the natural language processing,
wherein
said storage apparatus includes
the system dictionary information for use in the natural language processing, and
the user dictionary; and
said data processing apparatus includes
a word information registering unit that registers information on an input word into the user dictionary,
a difference creating unit that creates differences in a result of processing between a first result of processing when the natural language processing is performed by using the system dictionary information and a second result of processing when the natural language processing is performed by using the system dictionary information and the user dictionary information,
a correct-incorrect accepting unit that accepts correct-incorrect judgments as to whether changes from the first result of processing to the second result of processing are correct or incorrect, the changes corresponding to the differences created by said difference creating unit,
a parameter learning unit that calculates either one or a combination of a use condition and a using. score of the accepted word from the correct-incorrect judgments accepted, and
a dictionary registration unit that registers registration information on the accepted word into the user dictionary along with either one or a combination of the use condition and score calculated.

5. The dictionary registration system according to claim 4, wherein
said data processing apparatus further includes
a natural language analysis processing unit that, when an input to be analyzed by a natural language processing system includes words that are stored in the user dictionary, analyzes the input by using the information on the input words registered by said word information registering unit only if the use conditions on the words stored with the respective words are satisfied, or analyzes the input by using the scores stored with the respective words.

6. The dictionary registration system according to claim 2, wherein
said data processing apparatus:
further includes correct-incorrect feature ranking unit that ranks the correct-incorrect judgments in descending order of judgment capability in terms of features based on which the correct-incorrect judgments are made; and
calculates the use condition without using a correct-incorrect judgment that is based on a feature of lower order as an element of calculation of the use condition if the use condition can be calculated from only a correct-incorrect judgment or judgments that is/are based on a feature or features of higher judgment capability.

7. The dictionary registration system according to claim 2, wherein
said parameter learning unit determines the use condition of a word in the user dictionary by using any one or a combination of:
a condition that includes one or a combination of a headword, part of speech, conjugations, meaning classification, and other pieces of grammatical information on the word or a word lying in the vicinity of the word;
a condition as to whether the number of unknown words included in a result of morphological analysis increases or decreases depending on if the word is used or not;
a condition as to whether the success or failure of syntactic analysis depends on if the word is used or not;
a condition as to whether a morpheme boundary or part of speech of a word lying in the vicinity of the word varies depending on if the word is used or not;
a condition as to whether segmentation of a phrase that contains the word varies depending on if the word is used or not; and
a condition as to whether a destination of reference in a result of syntactic analysis of a word lying in the vicinity of the word varies depending on if the word is used or not.

8. A dictionary registration method for a system that performs natural language processing by using a user dictionary, the system including a data processing apparatus that performs the natural language processing by managing and using the user dictionary and a storage apparatus that retains system dictionary information and user dictionary information for use in the natural language processing, the method comprising:
a word information registering step in which said data processing apparatus registers information on an input word into the user dictionary;
a difference creating step in which said data processing apparatus creates differences in a result of processing between a first result of processing when the natural language processing is performed by using the system dictionary information and a second result of processing when the natural language processing is performed by using the system dictionary information and the user dictionary information;
a correct-incorrect accepting step in which said data processing apparatus accepts correct-incorrect judgments as to whether changes from the first result of processing to the second result of processing are correct or incorrect, the changes corresponding to the differences created by the difference creating step; and
a dictionary registration step in which said data processing apparatus registers registration information on the accepted word into the user dictionary along with part or all of pairs of the correct-incorrect judgments accepted and input sentences from which the differences given the respective correct-incorrect judgments are created.

9. The dictionary registration method according to claim 8, further comprising:
a parameter learning step in which said data processing apparatus calculates a use condition and a using score of the accepted word by using information on the pair(s) of the correct-incorrect judgment(s) and the input sentence(s) from which the difference(s) given the correct-incorrect judgment(s) is/are created, the pair(s) being stored with the word and registered in the user dictionary by the dictionary registration step; and
a natural language analysis processing step in which, when an input to be analyzed by a natural language processing system includes a word that is registered in the user dictionary by the dictionary registration step, said data processing apparatus analyzes the input by using the information on the input word registered by the word information registering step only if the use condition of the word calculated by the parameter learning step is satisfied, or analyzes the input by using the score calculated by the parameter learning step.

10. The dictionary registration method according to claim 8, further comprising
a use condition and using score recalculating step in which said data processing apparatus can accept an additional correct-incorrect judgment as to information on a pair of a target sentence of the registration information on the word accepted and an input sentence from which a difference given a correct-incorrect judgment is created, and recalculate the use condition and using score that are registered in the user dictionary by the dictionary registration step.

11. A dictionary registration method for a system that performs natural language processing by using a user dictionary, the system including a data processing apparatus that performs the natural language processing by managing and using the user dictionary and a storage apparatus that retains system dictionary information and user dictionary information for use in the natural language processing, the method comprising:
a word information registering step in which said data processing apparatus registers information on an input word into the user dictionary;
a difference creating step in which said data processing apparatus creates differences in a result of processing between a first result of processing when the natural language processing is performed by using the system dictionary information and a second result of processing when the natural language processing is performed by using the system dictionary information and the user dictionary information;
a correct-incorrect accepting step in which said data processing apparatus accepts correct-incorrect judgments as to whether changes from the first result of processing to the second result of processing are correct or incorrect, the changes corresponding to the differences created by the difference creating step;
a parameter learning step in which said data processing apparatus calculates either one or a combination of a use condition and a using score of the accepted word from the correct-incorrect judgments accepted; and
a dictionary registration step in which said data processing apparatus registers registration information on the accepted word into the user dictionary along with either one or a combination of the use condition and score calculated.

12. The dictionary registration method according to claim 11, further comprising
a natural language analysis processing step in which, when an input to be analyzed by a natural language processing system includes words that are stored in the user dictionary, said data processing apparatus analyzes the input by using the information on the input words registered by the word information registering step only if the use conditions on the words stored with the respective words are satisfied, or analyzes the input by using the scores stored with the respective words.

13. The dictionary registration method according to claim 9, further comprising
a correct-incorrect feature ranking step in which said data processing apparatus ranks the correct-incorrect judgments in descending order of judgment capability in terms of features based on which the correct-incorrect judgments are made,
said data processing apparatus calculating the use condition without using a correct-incorrect judgment that is based on a feature of lower order as an element of calculation of the use condition if the use condition can be calculated from only a correct-incorrect judgment or judgments that is/are based on a feature or features of higher judgment capability.

14. The dictionary registration method according to claim 9, wherein
in the parameter learning step, said data processing apparatus determines the use condition of a word in the user dictionary by using any one or a combination of:
a condition that includes one or a combination of a headword, part of speech, conjugations, meaning classification, and other pieces of grammatical information on the word or a word lying in the vicinity of the word;
a condition as to whether the number of unknown words included in a result of morphological analysis increases or decreases depending on if the word is used or not;
a condition as to whether the success or failure of syntactic analysis depends on if the word is used or not;
a condition as to whether a morpheme boundary or part of speech of a word lying in the vicinity of the word varies depending on if the word is used or not;
a condition as to whether segmentation of a phrase that contains the word varies depending on if the word is used or not; and
a condition as to whether a destination of reference in a result of syntactic analysis of a word lying in the vicinity of the word varies depending on if the word is used or not.

15. A computer-readable medium stored therein a dictionary registration program for performing natural language processing by managing and using a user dictionary, the program making a computer to implement:
a word information registering function of registering information on an input word into the user dictionary;
a difference creating function of creating differences in a result of processing between a first result of processing when the natural language processing is performed by using system dictionary information and a second result of processing when the natural language processing is performed by using the system dictionary information and the user dictionary information;
a correct-incorrect accepting function of accepting correct-incorrect judgments as to whether changes from the first result of processing to the second result of processing are correct or incorrect, the changes corresponding to the differences created by the difference creating function; and
a dictionary registration function of registering registration information on the accepted word into the user dictionary along with part or all of pairs of the correct-incorrect judgments accepted and input sentences from which the differences given the respective correct-incorrect judgments are created.

16. The computer-readable medium according to claim 15, the program making the computer further to implement:
a parameter learning function of calculating a use condition and a using score of the accepted word by using information on the pair(s) of the correct-incorrect judgment(s) and the input sentence(s) from which the difference(s) given the correct-incorrect judgment(s) is/are created, the pair(s) being stored with the word and registered in the user dictionary by the dictionary registration function; and
a natural language analysis processing function of, when an input to be analyzed by a natural language processing system includes a word that is registered in the user dictionary by the dictionary registration function, analyzing the input by using the information on the input word registered by the word information registering function only if the use condition of the word calculated by the parameter learning function is satisfied, or analyzing the input by using the score calculated by the parameter learning function.

17. The dictionary registration program according to claim 15, making the computer further to implement
a use condition and using score recalculating function capable of accepting an additional correct-incorrect judgment as to information on a pair of a target sentence of the registration information on the word accepted and an input sentence from which a difference given a correct-incorrect judgment is created, and of recalculating the use condition and using score that are registered in the user dictionary by the dictionary registration function.

18. A computer-readable medium stored therein a dictionary registration program for performing natural language processing by managing and using a user dictionary, the program making a computer to implement:
a word information registering function of registering information on an input word into the user dictionary;
a difference creating function of creating differences in a result of processing between a first result of processing when the natural language processing is performed by using system dictionary information and a second result of processing when the natural language processing is performed by using the system dictionary information and the user dictionary information;
a correct-incorrect accepting function of accepting correct-incorrect judgments as to whether changes from the first result of processing to the second result of processing are correct or incorrect, the changes corresponding to the differences created by the difference creating function;
a parameter learning function of calculating either one or a combination of a use condition and a using score of the accepted word from the correct-incorrect judgments accepted; and
a dictionary registration function of registering registration information on the accepted word into the user dictionary along with either one or a combination of the use condition and score calculated.

19. The computer-readable medium according to claim 18, the program making the computer further to implement
a natural language analysis processing function of, when an input to be analyzed by a natural language processing system includes words that are stored in the user dictionary, analyzing the input by using the information on the input words registered by the word information registering function only if the use conditions on the words stored with the respective words are satisfied, or analyzing the input by using the scores stored with the respective words.

20. The computer-readable medium according to claim 16, the program making the computer further to implement
a correct-incorrect feature ranking function of ranking the correct-incorrect judgments in descending order of judgment capability in terms of features based on which the correct-incorrect judgments are made, wherein
the use condition is calculated without using a correct-incorrect judgment that is based on a feature of lower order as an element of calculation of the use condition if the use condition can be calculated from only a correct-incorrect judgment or judgments that is/are based on a feature or features of higher judgment capability.

21. The computer-readable medium according to claim 16, wherein
in the parameter learning function, the use condition of a word in the user dictionary is determined by using any one or a combination of:
a condition that includes one or a combination of a headword, part of speech, conjugations, meaning classification, and other pieces of grammatical information on the word or a word lying in the vicinity of the word;
a condition as to whether the number of unknown words included in a result of morphological analysis increases or decreases depending on if the word is used or not;
a condition as to whether the success or failure of syntactic analysis depends on if the word is used or not;
a condition as to whether a morpheme boundary or part of speech of a word lying in the vicinity of the word varies depending on if the word is used or not;
a condition as to whether segmentation of a phrase that contains the word varies depending on if the word is used or not; and
a condition as to whether a destination of reference in a result of syntactic analysis of a word lying in the vicinity of the word varies depending on if the word is used or not.
